(19) United States
(12) Patent Application Publication
(10) Pub. No.: US 2025/0237936 A1
(43) Pub. Date: Jul. 24, 2025

(54) PROJECTION DEVICE AND PROJECTION SYSTEM

(71) Applicant: HISENSE LASER DISPLAY CO., LTD, Qingdao (CN)

(72) Inventors: Ke YAN, Qingdao (CN); Youliang TIAN, Qingdao (CN); Wei LI, Qingdao (CN)

(73) Assignee: HISENSE LASER DISPLAY CO., LTD, Qingdao (CN)

(21) Appl. No.: 19/082,215

(22) Filed: Mar. 18, 2025

Related U.S. Application Data
(63) Continuation of application No. PCT/CN2023/120461, filed on Sep. 21, 2023.

(30) Foreign Application Priority Data
Sep. 30, 2022 (CN) 202211208529.3
Sep. 30, 2022 (CN) 202211216165.3
Sep. 30, 2022 (CN) 202222623787.X

(51) Int. Cl. G03B 21/20

(52) U.S. Cl. CPC G03B 21/2033; G03B 21/2066; G03B 21/208

(57) ABSTRACT

A projection device and a projection system are provided. The projection device includes a light source, an optical modulating assembly, and a lens. The light source includes a laser and at least one optical waveguide. The laser includes first light emitting chips, second light emitting chips, and third light emitting chips. One of the at least one optical waveguide is located on a light outgoing side of the third light emitting chips. Each optical waveguide includes a light incident surface, a light outgoing surface, a light incident portion, and a light outgoing portion. The light incident surface and the light outgoing surface are opposite to each other in a thickness direction of the optical waveguide. The light incident portion is configured to introduce laser light incident thereon into the optical waveguide. The light outgoing portion is configured to transmit the laser light out of the optical waveguide.

### CROSS-REFERENCE TO RELATED APPLICATIONS

This application is a continuation of international PCT application No. PCT/CN2023/120461, filed on Sep. 21, 2023, which claims the priority benefit of Chinese patent application No. 202222623787.X, filed on Sep. 30, 2022, Chinese patent application no. 202211208529.3, filed on Sep. 30, 2022, and Chinese patent application No. 202211216165.3, filed on Sep. 30, 2022. The entirety of each of the above-mentioned patent applications is hereby incorporated by reference herein and made a part of this specification.

### TECHNICAL FIELD

The present disclosure relates to the field of laser projection technology, and in particular, to a projection device and a projection system.

### BACKGROUND

With the development of laser projection technology, projection devices have gradually entered people's lives and become a common item in people's work and life. Alight source in the projection device can emit lasers of various colors, which are modulated to form a projection image.

### SUMMARY

In one aspect, a projection device is provided. A projection device includes a light source, an optical modulating assembly, and a lens. The light source is configured to emit laser light of a plurality of colors as an illumination beam. The optical modulating assembly is configured to modulate the illumination beam to obtain a projection beam. The lens is located on a light outgoing side of the optical modulating assembly and is configured to project the projection beam to form a projection image. The light source includes at least one laser and at least one optical waveguide. The at least one laser includes a plurality of first light emitting chips, a plurality of second light emitting chips, and a plurality of third light emitting chips. The plurality of first light emitting chips are configured to emit red laser light. The plurality of second light emitting chips are configured to emit blue laser light. The plurality of third light emitting chips are configured to emit green laser light. A number of the plurality of third light emitting chips and a number of the plurality of second light emitting chips are smaller than a number of the plurality of first light emitting chips, respectively. One of the at least one optical waveguide is located on a light outgoing side of the plurality of third light emitting chips. Each optical waveguide includes a light incident surface, a light outgoing surface, a light incident portion, and a light outgoing portion. The light incident surface is a surface of the optical waveguide adjacent to the laser. The light outgoing surface is parallel to the light incident surface. The light incident surface and the light outgoing surface are opposite to each other in a thickness direction of the optical waveguide. The light incident portion is configured to introduce laser light incident thereon into the optical waveguide. The light outgoing portion is configured to transmit the laser light out of the optical waveguide. The light incident portion and the light outgoing portion are located between the light incident surface and the light outgoing surface. A beam width of the laser light emitted from the light outgoing portion is equal to a beam width of the red laser light emitted from the plurality of first light emitting chips.

In another aspect, a projection system is provided. The projection system includes the above-mentioned projection device and a projection screen located on a light outgoing side of the projection device.

### BRIEF DESCRIPTION OF THE DRAWINGS

In order to describe the technical solution in the present disclosure more clearly, the following briefly describes the accompanying drawings required for some embodiments of the present disclosure. However, the accompanying drawings in the following description are merely the drawings of some embodiments of the present disclosure. For those skilled in the art, other drawings may be obtained according to these drawings. In addition, the drawings in the following description may be regarded as schematic diagrams, and are not limited to the actual size of the product, the actual process of the method, the actual timing of the signal, etc., of the embodiments of the present disclosure.

FIG. 1 is a graph showing an energy distribution of laser light in the related art.

FIG. 2 is a graph showing an energy distribution of another laser light in the related art.

FIG. 3 is a schematic structural view of a projection system according to some embodiments.

FIG. 4 is a perspective view of a projection device according to some embodiments.

FIG. 5 is a diagram of a light path between a light source, an optical modulating assembly, and a lens in a projection device according to some embodiments.

FIG. 6 is a schematic structural view of a light source according to some embodiments.

FIG. 7 is a schematic structural view of a light source according to other embodiments.

FIG. 8 is a graph showing an energy distribution of laser light according to some embodiments.

FIG. 9 is a schematic structural view of a projection system according to other embodiments.

FIG. 10A is a cross-sectional view of a diffraction microstructure in a diffractive optical member according to some embodiments.

FIG. 10B is a cross-sectional view of a diffraction microstructure in a diffractive optical member according to other embodiments.

FIG. 10C is a cross-sectional view of a diffraction microstructure in a diffractive optical member according to yet other embodiments.

FIG. 11 is a schematic structural view of a light source according to yet other embodiments.

FIG. 12 is a schematic structural view of a light source according to yet other embodiments.

FIG. 13 is a schematic structural view of a light source according to yet other embodiments.

FIG. 14 is a schematic structural view of a light source according to yet other embodiments.

FIG. 15 is a schematic structural view of a light source according to yet other embodiments.

FIG. 16 is a schematic structural view of a light source according to yet other embodiments.

FIG. 17 is a schematic structural view of a light source according to yet other embodiments.

FIG. 18 is a schematic structural view of a light source according to yet other embodiments.

FIG. 19 is a schematic structural view of a light source according to yet other embodiments.

FIG. 20 is a schematic structural view of a light source according to yet other embodiments.

FIG. 21 is a schematic structural view of a light source according to yet other embodiments.

FIG. 22 is a schematic structural view of a light source according to yet other embodiments.

FIG. 23 is a schematic structural view of a light source according to yet other embodiments.

FIG. 24 is a perspective view of a projection device according to other embodiments.

FIG. 25 is a diagram showing a light path between a light source and a light guide according to some embodiments.

FIG. 26 is a schematic structural view of a laser according to some embodiments.

FIG. 27 is a schematic structural view of a light source according to yet other embodiments.

FIG. 28 is a diffraction diagram of a volume grating according to some embodiments.

FIG. 29 is a schematic structural view of a volume grating and a light valve according to some embodiments.

FIG. 30 is a perspective view of an optical modulating assembly in a projection device according to some embodiments.

FIG. 31 is a perspective view of an optical modulating assembly in a projection device according to other embodiments.

FIG. 32 is a schematic structural view of a projection device according to yet other embodiments.

FIG. 33 is a schematic structural view of an array optical waveguide according to some embodiments.

FIG. 34 is a schematic structural view of a sawtooth-shaped optical waveguide according to some embodiments.

FIG. 35 is a light path diagram of a light source according to yet other embodiments.

FIG. 36 is a light path diagram of a light source according to yet other embodiments.

FIG. 37 is a schematic structural view of a projection device according to yet other embodiments.

FIG. 38 is a light path diagram of a light source according to yet other embodiments.

FIG. 39 is a light path diagram of a light source according to yet other embodiments.

FIG. 40 is a light path diagram of a light source according to yet other embodiments.

### DETAILED DESCRIPTION OF THE EMBODIMENTS

In order to make the above objects, features and advantages of the present disclosure clear and easier to understand, the specific embodiments of the present disclosure are described in detail below in combination with the accompanying drawings. Many specific details are set forth in the following description to facilitate a full understanding of the present disclosure. However, the present disclosure can be implemented in many ways different from those described herein, and those skilled in the art can make similar improvements without departing from the connotation of the present disclosure. Therefore, the present disclosure is not limited by the specific embodiments disclosed below.

Unless the context otherwise requires, in the entire specification and claims, the term “include” and its other forms such as the third person singular form “includes” and the present participle form “including” are construed as open and inclusive, that is, “includes, but is not limited to”. In the specification, the terms “one embodiment”, “some embodiments”, “exemplary embodiment”, “example”, “specific example” or “some examples” and the like are intended to indicate that specific features, structures, materials, or characteristics related to this embodiment or example are included in at least one embodiment or example of the present disclosure. The illustrative expression of the above terms does not necessarily refer to the same embodiment or example. Furthermore, the specific features, structures, materials or characteristics described herein may be combined in a suitable manner in any one or more embodiments or examples.

Hereinafter, the terms “first” and “second” are only intended for illustrative purposes, rather than being construed as indicating or implying relative importance or implicitly designating the number of the technical features as indicated. Thus, a feature defined by “first” or “second” may explicitly or implicitly include one or more said features. In the illustrations of the present disclosure, the term “a plurality of” means two or more, unless otherwise specifically defined.

When describing some embodiments, expressions such as “connection” and its derivatives may be used. The term “connection” shall be construed broadly, for example, “connection” may be a fixed connection, a detachable connection, or an integral connection. It can be a direct connection or an indirect connection through an intermediate medium. The embodiments disclosed herein are not necessarily limited to the content herein.

“At least one of A, B, and C” has the same meaning as “at least one of A, B, or C” and includes the following combinations of A, B, and C: only A, only B, only C, a combination of A and B, a combination of A and C, a combination of B and C, and a combination of A, B, and C.

The use of “adapted to” or “configured to” herein implies an open and inclusive language, which does not exclude devices that are adapted or configured to perform additional tasks or steps.

As used herein, “about”, “around” or “approximate” includes the values set forth and an average value within an acceptable deviation range of a particular value, wherein the acceptable deviation range is as determined by one of ordinary skill in the art, taking into account the measurement under discussion and errors associated with a particular amount of measurement, i.e., limitations of the measurement system.

Generally, in a projection device, before an illumination beam emitted from a light source is incident on an optical modulation member, the illumination beam needs to be homogenized and shaped by a light homogenizing member (such as a light guide) and a corresponding lens assembly to improve the display effect of a projection image.

However, since the light guide is long and the lens assembly includes at least two lenses with a certain distance therebetween, a volume of the projection device is large, which is difficult to meet the requirement for miniaturization of the projection device. In addition, although the longer the light guide is, the better the uniformity effect of the light guide on the illumination beam is, a length of the light guide is limited due to the requirement of miniaturization of the projection device, which affects the upper limit of the display effect of the projection image.

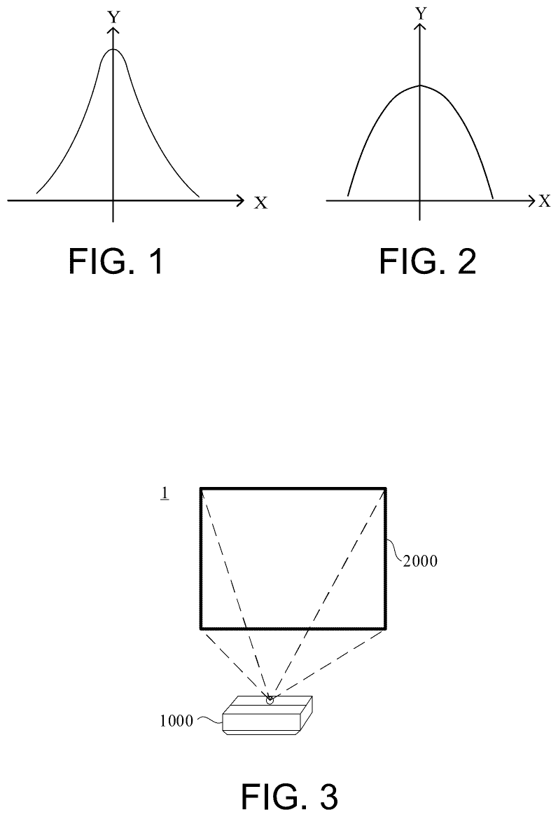

FIG. 1 is a graph showing an energy distribution of laser light in the related art. As shown in FIG. 1, a horizontal axis X represents positions of the laser light in a laser beam, and a vertical axis Y represents an energy (e.g., intensity) of the laser light. The energy of the laser light emitted from each light emitting chip in the laser 101 is distributed in a Gaussian manner, and most of the energy is concentrated in a middle region of the laser beam. In this case, the color uniformity of a projection image formed by the laser light is poor.

FIG. 2 is a graph showing an energy distribution of another laser light in the related art. In some solutions, a diffusion sheet may be used to diffuse the laser light to achieve homogenization. For example, as shown in FIG. 2, after being diffused by the diffusion sheet, an energy of the middle region of the laser beam is still relatively high, an energy of an edge portion of the laser beam is still relatively low, and the uniformity of the laser beam is relatively low. Although the uniformity of the energy of the laser beam can be improved by increasing a diffusion angle of the diffusion sheet, a large amount of edge energy will be lost, resulting in a lower utilization rate of the laser light.

In order to solve the above problem, a projection system 1 is provided according to some embodiments.

FIG. 3 is a schematic structural view of a projection system according to some embodiments. As shown in FIG. 3, the projection system 1 includes a projection device 1000 and a projection screen 2000. The projection screen 2000 is located on a light outgoing side of the projection device 1000, and the projection screen 2000 is configured to face viewers. A projection beam emitted from the projection device 1000 is incident on the projection screen 2000, and is reflected by the projection screen 2000 to enter the human eyes, so that the viewer can view the projection image.

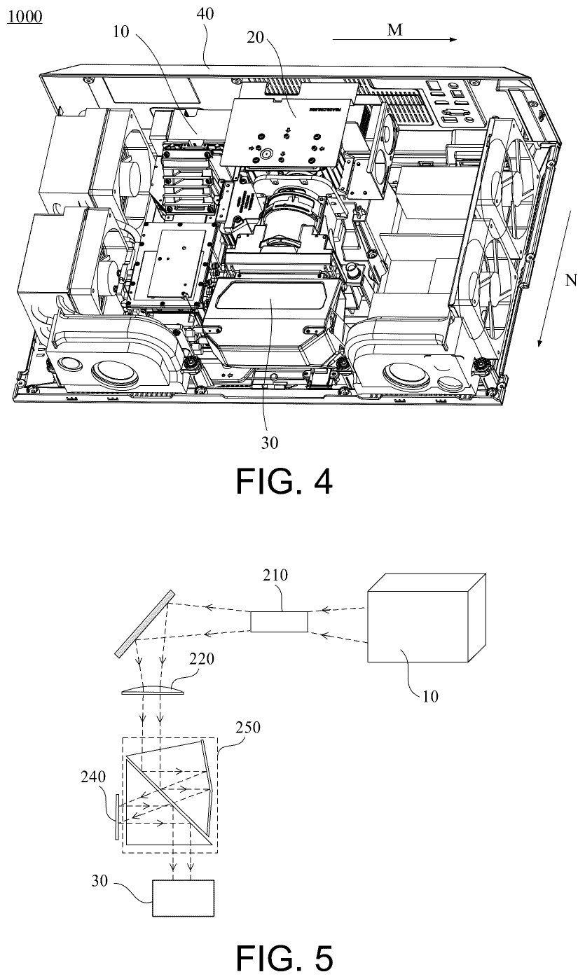

FIG. 4 is a perspective view of a projection device according to some embodiments. As shown in FIG. 4, the projection device 1000 includes a housing 40 (only a part of the housing 40 is shown in FIG. 4), a light source 10 mounted in the housing 40, an optical modulating assembly 20, and a lens 30. The light source 10 is configured to provide an illumination beam (e.g., laser light). The optical modulating assembly 20 is configured to modulate the illumination beam provided by the light source 10 with an image signal to obtain a projection beam. The image signal may come from a control unit communicatively connected to the projection device 1000, and the control unit generates the image signal according to an image to be projected and transmits the image signal to the projection device 1000. The lens 30 is configured to project the projection beam onto the projection screen 2000 or a wall to form a projection image.

The light source 10, the optical modulating assembly 20, and the lens 30 are sequentially connected along a propagation direction of the light beam, and are each enclosed by portions of the housing 40. The portions of the housing 40 respectively corresponding to the light source 10, the optical modulating assembly 20, and the lens 30 support corresponding optical components and enable the optical components to meet certain sealing or airtight requirements.

One end of the optical modulating assembly 20 is connected to the light source 10, and the light source 10 and the optical modulating assembly 20 are provided along an outgoing direction (refer to a direction M in FIG. 4) of the illumination beam of the projection device 1000. The other end of the optical modulating assembly 20 is connected to the lens 30, and the optical modulating assembly 20 and the lens 30 are provided along an outgoing direction (refer to a direction N in FIG. 4) of the projection beam of the projection device 1000. The outgoing direction M of the illumination beam is substantially perpendicular to the outgoing direction N of the projection beam. Such a connection structure can adapt to the light path characteristics of a reflective light valve in the optical modulating assembly 20. Meanwhile, it is also beneficial to shortening a length of the light path in one dimensional direction, which is beneficial to the structural arrangement of the whole device. For example, when the light source 10, the optical modulating assembly 20, and the lens 30 are provided in one dimensional direction (e.g., the direction M), the length of the light path in the dimensional direction will be very long, which is not conducive to the structural arrangement of the whole device. The reflective light valve will be described later.

In some embodiments, the light source 10 may provide three primary colors of light in a time-sequential manner, and may also provide other colors of light on the basis of the three primary colors of light. Due to the persistence of vision of the human eyes, the human eyes see white light formed by the mixture of the three primary colors of light. Alternatively, the light source 10 may simultaneously emit three primary colors of light and continuously emit white light.

FIG. 5 is a diagram of a light path between a light source, an optical modulating assembly, and a lens in a projection device according to some embodiments. As shown in FIG. 5, the optical modulating assembly 20 includes a light homogenizing member 210, a lens assembly 220, a light valve 240 (i.e., an optical modulation member), and a prism assembly 250. The light homogenizing member 210 is configured to homogenize the illumination beam incident thereon and transmit the illumination beam to the lens assembly 220. The lens assembly 220 may first collimate the illumination beam and then converge the illumination beam and transmit the illumination beam to the prism assembly 250. The prism assembly 250 reflects the illumination beam to the light valve 240. The light valve 240 is configured to modulate the illumination beam incident thereon into the projection beam according to the image signal, and to direct the projection beam toward the lens 30.

In some embodiments, the light homogenizing member 210 may include a light guide or a fly-eye lens assembly. For example, the light homogenizing member 210 includes a light guide having a rectangular light inlet. The illumination beam from the light source 10 is incident into the light guide and is reflected in the light guide for transmission at random angles, thereby improving the uniformity of the illumination beam transmitted from the light guide.

For another example, the light homogenizing member 210 includes a fly-eye lens assembly composed of two fly-eye lenses opposite to each other, and the fly-eye lens is formed by a plurality of microlens in an array. Along the incident direction of the illumination beam, a focal point of the microlens in a first fly-eye lens coincides with a center of the corresponding microlens in a second fly-eye lens, and optical axes of the microlenses in the two fly-eye lenses are parallel to each other. By the fly-eye lens assembly, the light spot of the illumination beam can be divided. In addition, the divided spots can be accumulated by the lens assembly 220. In this way, the illumination beam can be homogenized. It should be noted that the light homogenizing member 210 may alternatively be provided in the light source 10. For example, the light source 10 includes the light homogenizing member 210, and in this case, the light homogenizing member 210 may not be provided in the optical modulating assembly 20.

The lens assembly 220 may include a convex lens, such as a plano-convex lens, a biconvex lens, or a concave-convex lens (also known as a positive meniscus lens). The convex lens may be a spherical lens or an aspherical lens.

The prism assembly 250 may be a total internal reflection (TIR) prism assembly or a total refraction total Internal reflection (RTIR) prism assembly.

The light valve 240 may be a reflective light valve. The light valve 240 includes a plurality of reflection sheets, each of which may be configured to form a pixel in the projection image. The light valve 240 may adjust the plurality of reflection sheets according to an image to be displayed, so that the reflection sheet corresponding to the pixel to be displayed in a bright state in the image reflects the light beam to the lens 30, and the light beam reflected to the lens 30 is referred to as the projection beam. In this way, the light valve 240 can modulate the illumination beam to obtain the projection beam, and the projection image is displayed through the projection beam.

In some embodiments, the light valve 240 may be a digital micromirror device (DMD). The digital micromirror device includes a plurality (e.g., thousands) of tiny reflection mirrors that can be individually driven to rotate. The tiny reflection mirrors may be arranged in an array. One tiny reflection mirror (e.g., each tiny reflection mirror) corresponds to one pixel in the projection image to be displayed. After processing, the image signal can be converted into digital codes such as 0 and 1. In response to the digital codes, the tiny reflection mirror can oscillate. A gray scale of each pixel in a frame of image is achieved by controlling a duration of each tiny reflection mirror in an on state and an off state. In this way, the digital micromirror device can modulate the illumination beam to display the projection image.

The lens 30 includes a plurality of lens groups, which are generally divided into three groups, i.e., a front group, a middle group, and a rear group, or two groups, i.e., a front group and a rear group. The front group is a lens group adjacent to the light outgoing side of the projection device 1000, that is, a lens group away from the light outgoing side of the optical modulating assembly 20. The rear group is a lens group adjacent to the light outgoing side of the optical modulating assembly 20. The lens 30 may be a zoom lens, or a prime adjustable lens, or a prime lens. In some embodiments, the projection device 1000 may be an ultra-short throw projection device, and the lens 30 may be an ultra-short throw projection lens.

For the convenience of description, some embodiments of the present disclosure are mainly described by taking the projection device 1000 adopting a digital light processing (DLP) projection architecture and the light valve 240 being a digital micromirror device as an example, which does not limit the present disclosure.

The light source 10 in some embodiments of the present disclosure is described in detail below.

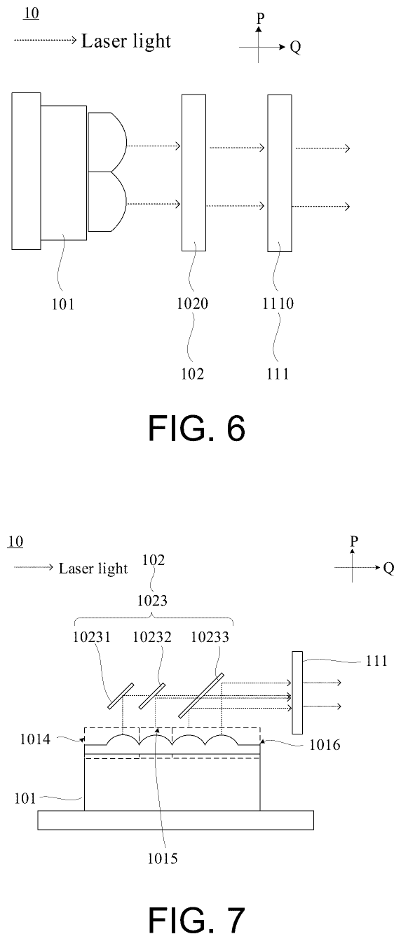

FIG. 6 is a schematic structural view of a light source according to some embodiments. In some embodiments, as shown in FIG. 6, the light source 10 includes a laser 101.

The laser 101 is configured to emit laser light of a plurality of colors. For example, the laser 101 includes a plurality of light outgoing regions, each of the plurality of light outgoing regions may emit laser light of one color, and different light outgoing regions may emit laser light of different colors.

FIG. 7 is a schematic structural view of a light source according to other embodiments. For example, as shown in FIG. 7, the laser 101 includes a first light outgoing region 1014, a second light outgoing region 1015, and a third light outgoing region 1016. The first light outgoing region 1014, the second light outgoing region 1015, and the third light outgoing region 1016 are sequentially arranged along a second direction Q, and the three light outgoing regions respectively emit laser light of three different colors. For example, the first light outgoing region 1014 emits green laser light, the second light outgoing region 1015 emits blue laser light, and the third light outgoing region 1016 emits red laser light.

Each of the plurality of light-emitting regions may include a plurality of light-emitting chips, and each of the plurality of light emitting chips may be configured to emit a beam of laser light. In the present disclosure, the number of the light outgoing regions of the laser 101 and the color of the laser light emitted from each light outgoing region are not limited.

As shown in FIG. 6 and FIG. 7, the light source 10 further includes a light combining member 102 and a beam reshaping member 111. The laser light of the plurality of colors emitted from the laser 101 are directed to the light combining member 102. The light combining member 102 is located on a light outgoing side of the laser 101 and is configured to combine the laser light of different colors emitted from the laser 101. The laser light transmitted from the light combining member 102 is directed to the beam reshaping member 111. The beam reshaping member 111 is located on a light outgoing side of the light combining member 102 and is configured to homogenize and shape the laser light combined by the light combining member 102. For example, the beam reshaping member 111 shapes the received laser light, so that the laser light transmitted from the beam reshaping member 111 can form a rectangular spot.

In some embodiments, the beam reshaping member 111 may be a diffractive optical element (DOE). The diffractive optical element is a two-dimensional diffractive device, and can directly adjust the received laser light in two directions. For example, the diffractive optical element diffracts the laser light in a fast axis direction and a slow axis direction of the incident laser light, so that the laser light emitted from the diffractive optical element can be adapted to a required light spot. The diffractive optical element may alternatively diffract the incident laser light in two other directions perpendicular to each other, which is not limited in the present disclosure.

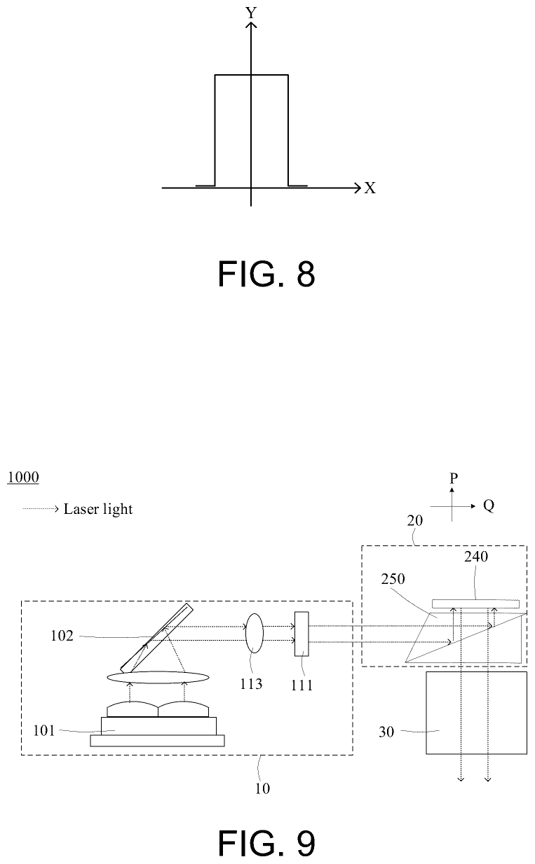

FIG. 8 is a graph showing an energy distribution of laser light according to some embodiments. FIG. 9 is a schematic structural view of a projection system according to other embodiments.

In the case where the light modulation member 111 is a diffractive optical element, as shown in FIG. 8, the energy distribution of the laser light at each position after passing through the light modulation member 111 may be substantially the same, and the energy distribution of the laser light has high uniformity and high utilization rate. Thus, as shown in FIG. 9, after passing through the beam reshaping member 111, the illumination beam emitted from the light source 10 can be directly incident on the prism assembly 250 and be reflected to the light valve 240 by the prism assembly 250, so that the light valve 240 can modulate the illumination beam. Therefore, there is no need to provide the lens assembly 220 and the light homogenizing member 210 which occupy a large volume, so that the structure of the projection device 1000 can be reduced, which is conducive to miniaturization of the projection device 1000.

In some embodiments, the diffractive optical element may include a plurality of diffraction microstructures distributed in two dimensions formed by a micro-nano etching process. The plurality of diffraction microstructures may have different shapes, sizes, and refractive indices to correspond to different wavelengths, different light intensities, or different incident angles of the laser light. The fine regulation of the laser may be achieved through the plurality of diffraction microstructures. For example, the plurality of diffraction microstructures are respectively rectangular, sizes and depths (or heights) of a plurality of diffraction microstructures may be different, and distances between different diffraction microstructures may be different, so as to achieve targeted adjustment of the incident laser light. The diffractive optical element may alliteratively be a multi-layer structure superimposed on each other, in which case the diffraction microstructure may be a structure of two or more layers.

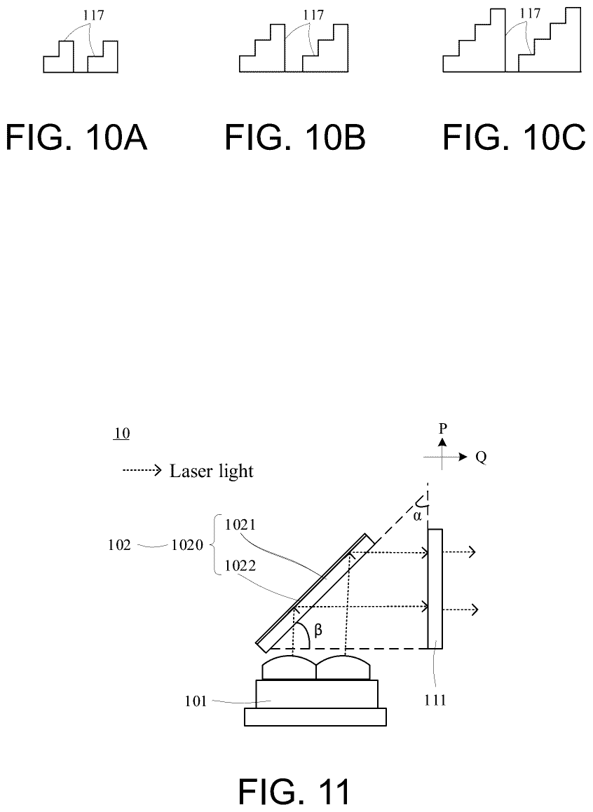

FIG. 10A, FIG. 10B, and FIG. 10C are each a cross-sectional view of a diffraction microstructure in a diffractive optical member according to some embodiments.

For example, referring to FIG. 10A, FIG. 10B, and FIG. 10C, three kinds of diffraction microstructures 117 are shown. The cross-sectional view of different diffraction microstructures 117 in the diffractive optical element may be any one of the three diffraction microstructures 117. The FIG. 10A, FIG. 10B, and FIG. 10C respectively illustrate that the diffraction microstructure 117 includes a two-layer, three-layer or four-layer structure as an example. The diffraction microstructure 117 may alternatively include other layer structures, for example, the diffraction microstructure 117 includes an eight-layer or sixteen-layer structure.

It should be noted that as the number of layers of the diffraction microstructure 117 increases, the diffraction efficiency of the diffractive optical element and the homogenization and shaping ability of the laser light are respectively improved, and the ability of the diffractive optical element to improve the uniformity of energy distribution of the laser light is also improved. However, the more layers of the diffraction microstructure 117 there are, the more difficult it is to process. Therefore, the number of layers of the diffraction microstructure 117 should be within a predetermined range. For example, the number of layers of the diffraction microstructure 117 is greater than or equal to 8 and less than or equal to 16. In addition, based on the amplitude distribution of the laser light incident on the diffractive optical element, the phase of the incident laser light, and the required amplitude distribution of the laser light, through diffraction theory and optimization algorithm, such as Gale-Shapley algorithm, simulated annealing algorithm, genetic algorithm (GA), etc., the parameters, such as shape, size, refractive index, etc., corresponding to the plurality of diffraction microstructures 117 in the diffraction optical element can be calculated.

In some embodiments, the diffractive optical element includes a transmissive diffractive optical element and a reflective diffractive optical element. The transmissive diffractive optical element can transmit the laser light, and the reflective diffractive optical element can reflect the laser light.

For example, as shown in FIG. 6, the beam reshaping member 111 includes a first diffractive optical element 1110. The first diffractive optical element 1110 is configured to homogenize and shape the laser light incident thereon. For example, as shown in FIG. 6, the first diffractive optical element 1110 includes a transmissive diffractive optical element. In some embodiments, the beam reshaping member 111 may also include a reflective diffractive optical element, which is not limited in the present disclosure.

In some embodiments of the present disclosure, the light source 10 includes a beam reshaping member 111, and the beam reshaping member 111 is configured to homogenize and shape the laser light after the laser light of the plurality of colors are combined by the light combining member 102, so that a lens assembly and a light homogenizing member occupying a large volume do not need to be provided, and the components in the optical modulating assembly 20 can be reduced. Moreover, the volume of the first diffractive optical element 1110 is smaller, thereby reducing the volume of the optical modulating assembly 20, facilitating the miniaturization of the projection device 1000, and also facilitating the improvement of the uniformity of energy distribution of the laser light.

The light combining member 102 in some embodiments of the present disclosure is described in detail below.

In some embodiments, the light combining member 102 may be a diffractive optical element, and the light combining member 102 is configured to adjust transmission directions of the laser light incident at different positions thereof, so that the laser light of different colors is directed to the same region, thereby combining the laser light of different colors. It should be noted that combining the laser light may refer to adjusting the laser light of different colors transmitted from the light combining member 102 to the same light path, so that the laser light of different colors can be incident on the same region.

In some examples, as shown in FIG. 6, the light combining member 102 includes a second diffractive optical element 1020. The second diffractive optical element 1020 is configured to adjust transmission directions of the laser light incident at different positions thereof, so that the laser light of different colors is directed to the same region. For example, the second diffractive optical element 1020 includes a transmissive diffractive optical element. At this time, the second diffractive optical element 1020 is configured to transmit the laser light incident thereon and combine the laser light of the plurality of colors. An incident direction of the laser light passing through the light combining member 102 is the same as an outgoing direction of the laser light. For example, as shown in FIG. 6, the laser light emitted from the laser 101 is incident on the second diffractive optical element 1020 along the second direction Q, and is transmitted out of the diffractive optical element 1020 along the second direction Q after being combined by the second diffractive optical element 1020.

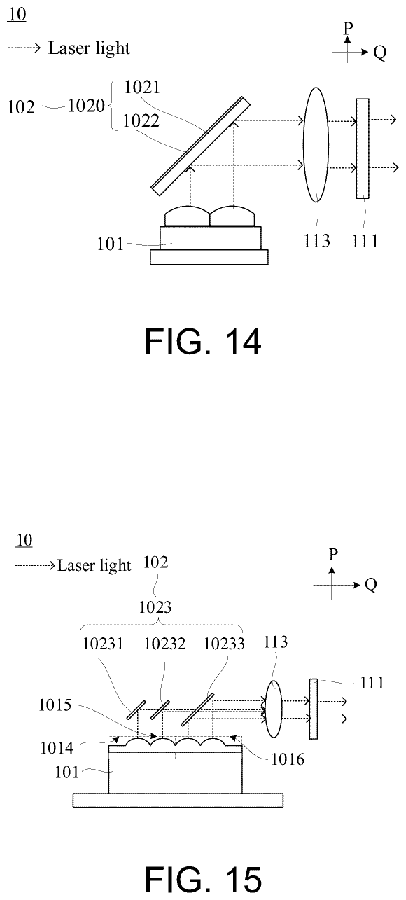

FIG. 14 is a schematic structural view of a light source according to yet other embodiments.

As another example, as shown in FIG. 11, the second diffractive optical element 1020 includes a reflective diffractive optical element. At this time, the second diffractive optical element 1020 is configured to reflect the laser light incident thereon and combine the laser light of the plurality of colors. An incident direction of the laser light passing through the second diffractive optical element 1020 may be different from an outgoing direction of the laser light.

For example, as shown in FIG. 11, the laser 101 and the second diffractive optical element 1020 are arranged along a first direction P, and the second diffractive optical element 1020 and the beam reshaping member 111 are arranged along the second direction Q. The second diffractive optical element 1020 is inclined with respect to the light outgoing direction (e.g., the first direction P in FIG. 11) of the laser light emitted from the laser 101, and the second diffractive optical element 1020 forms a first angle α with respect to the first direction P and forms a second angle β with respect to the second direction Q. For example, the first angle α and the second angle β are 45 degrees, respectively. The laser light emitted from the laser 101 is incident on the second diffractive optical element 1020 along the first direction P, and is reflected to the beam reshaping member 111 along the second direction Q after being combined by the second diffractive optical element 1020. The first direction P may be perpendicular to the second direction Q. The first direction P may alternatively not be perpendicular to the second direction Q, which is not limited in the present disclosure.

As shown in FIG. 11, in the case where the second diffractive optical element 1020 includes the reflective diffractive optical element, the second diffractive optical element 1020 includes a diffractive element body 1021 and a reflection film 1022. The reflection film 1022 is located on a side of the diffractive element body 1021 away from the laser 101. The diffractive element body 1021 is configured to combine the laser light of a plurality of colors incident thereon. The reflection film 1022 is configured to reflect the combined laser light.

In some embodiments of the present disclosure, the light combining member 102 includes a second diffractive optical element 1020, and the second diffractive optical element 1020 can adjust transmission directions of the laser light incident at different positions thereof, so that the laser light of different colors is directed to the same region, thereby combining of the laser light of different colors. In this way, the light combining effect of lasers light of different colors can be improved, and the uniformity of the energy distribution of the laser light can be improved.

In other embodiments, the light combining member 102 may include a plurality of light combining mirrors.

In some embodiments, as shown in FIG. 7, the light combining member 102 includes a plurality of light combining mirrors 1023 provided along the second direction Q. Each of the plurality of light combining mirrors 1023 is configured to reflect the laser light of one color emitted from the laser 101, so that the plurality of light combining mirrors 1023 can combine the laser light of the plurality of colors.

On a plane perpendicular to the second direction Q, orthographic projections of the plurality of light combining mirrors 1023 at least partially coincide. The plurality of light combining mirrors 1023 includes a seventh light combining mirror 10231, an eighth light combining mirror 10232, and a ninth light combining mirror 10233. The seventh light combining mirror 10231 corresponds to the first light outgoing region 1014, the eighth light combining mirror 10232 corresponds to the second light outgoing region 1015, and the ninth light combining mirror 10233 corresponds to the third light outgoing region 1016. For example, each of the three light combining mirrors 1023 is located on the light outgoing side of the corresponding light outgoing region, and the orthographic projection of each light combining mirror 1023 on the laser 101 may cover the corresponding light outgoing region.

The laser light transmitted from the three light outgoing regions are directed to the corresponding light combining mirrors 1023, and each of the three light combining mirrors 1023 is configured to reflect the laser light emitted from the corresponding light outgoing region along the second direction Q. For example, the seventh light combining mirror 10231 reflects the laser light emitted from the first light outgoing region 1014 along the second direction Q, the eighth light combining mirror 10232 reflects the laser light emitted from the second light outgoing region 1015 along the second direction Q, and the ninth light combining mirror 10233 reflects the laser light emitted from the third light outgoing region 1016 along the second direction Q.

At least one of the three light combining mirrors 1023 is also configured to transmit the laser light transmitted from the other light combining mirrors 1023 in the second direction Q. For example, the eighth light combining mirror 10232 may transmit the laser light reflected by the seventh light combining mirror 10231, the ninth light combining mirror 10233 may transmit the laser light reflected by the eighth light combining mirror 10232 and the laser light transmitted by the eighth light combining mirror 10232. The eighth light combining mirror 10232 and the ninth light combining mirror 10233 may each be a dichroic mirror. For example, the eighth light combining mirror 10232 is a dichroic mirror that transmits green light and reflects blue light, and the ninth light combining mirror 10233 is a dichroic mirror that transmits blue light and green light and reflects red light. In this way, the laser light of different colors emitted from the laser device 101 can be transmitted out of the ninth light combining mirror 10233, respectively, so as to combine the laser light of the plurality of colors emitted from the laser 101.

In the foregoing description, the light source 10 including the laser 101, the light combining member 102, and the beam reshaping member 111. In some embodiments, the light source 10 may further include other components.

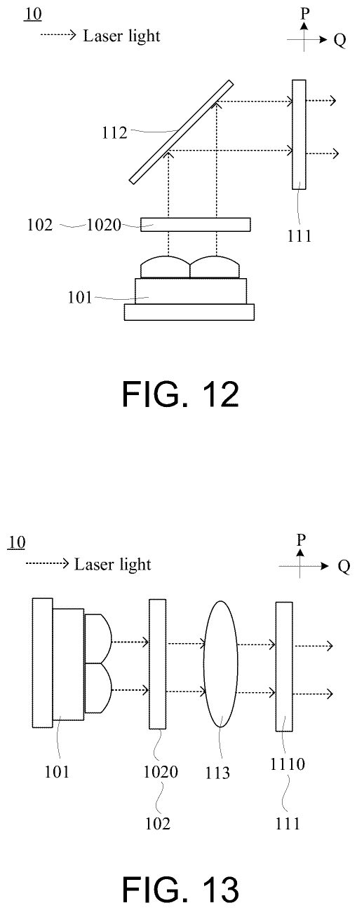

FIG. 12 is a schematic structural view of a light source according to yet other embodiments.

In some embodiments, as shown in FIG. 12, in the case where the light combining member 102 includes the transmissive diffractive optical element, the light source 10 further includes a second reflection mirror 112. The second reflection mirror 112 is located between the light combining member 102 and the beam reshaping member 111, and is configured to reflect the laser light combined by the light combining member 102 to the beam reshaping member 111, so as to fold the light path, thereby preventing a length of the light source 10 from being too long in a certain direction, and facilitating miniaturization of the light source 10. The laser 101, the light combining member 102, and the second reflection mirror 112 are sequentially arranged along the first direction P, and the second reflection mirror 112 and the beam reshaping member 111 are sequentially arranged along the second direction Q. The laser light of the plurality of colors combined by the light combining member 102 can be directed to the second reflection mirror 112, and the transmission direction of the laser light is changed by the second reflection mirror 112, and then the laser light is directed to the beam reshaping member 111.

FIG. 13 is a schematic structural view of a light source according to yet other embodiments. The light source 10 in FIG. 13 is based on the light source 10 in FIG. 6 and further includes a first lens 113. FIG. 14 is a schematic structural view of a light source according to yet other embodiments. The light source 10 in FIG. 14 is based on the light source 10 in FIG. 11 and further includes a first lens 113. FIG. 15 is a schematic structural view of a light source according to yet other embodiments. The light source 10 in FIG. 15 is based on the light source 10 in FIG. 7 and further includes a first lens 113.

In some embodiments, as shown in FIGS. 13 to 15, the light source 10 further includes the first lens 113 located on a light path between the light combining member 102 and the beam reshaping member 111. The first lens 113 is configured to collimate the laser light incident thereon, so that the beam reshaping member 111 can receive the collimated laser light. In this way, the poor diffraction processing effect of the diffractive optical element due to uncertainty in the incident direction of the divergent laser light can be avoided, thereby improving the homogenization and shaping effect of the laser light by the beam reshaping member 111.

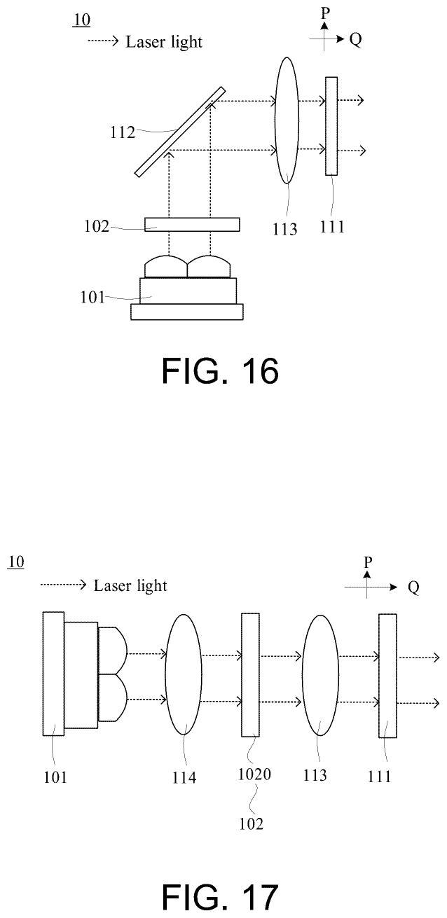

FIG. 16 is a schematic structural view of a light source according to yet other embodiments. The light source 10 in FIG. 16 is based on the light source 10 in FIG. 12 and further includes a first lens 113.

In some embodiments, as shown in FIG. 16, in the case where the light source 10 includes the second reflection mirror 112, the first lens 113 is located between the second reflection mirror 112 and the beam reshaping member 111.

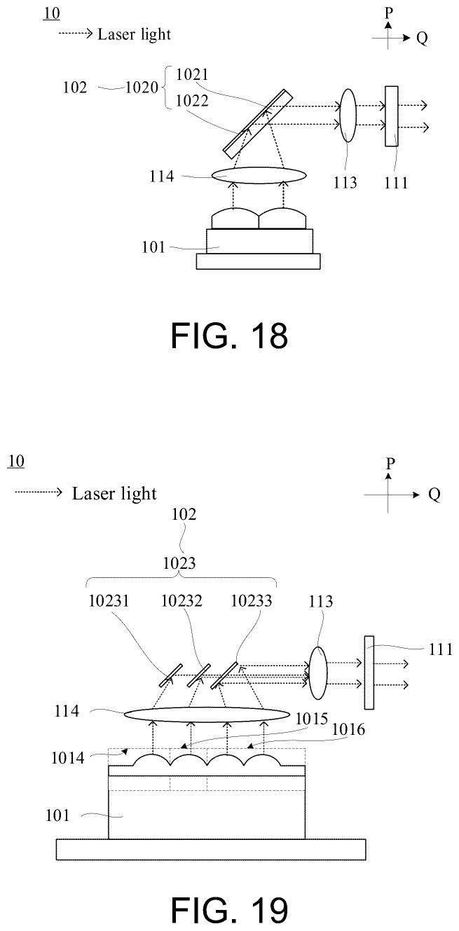

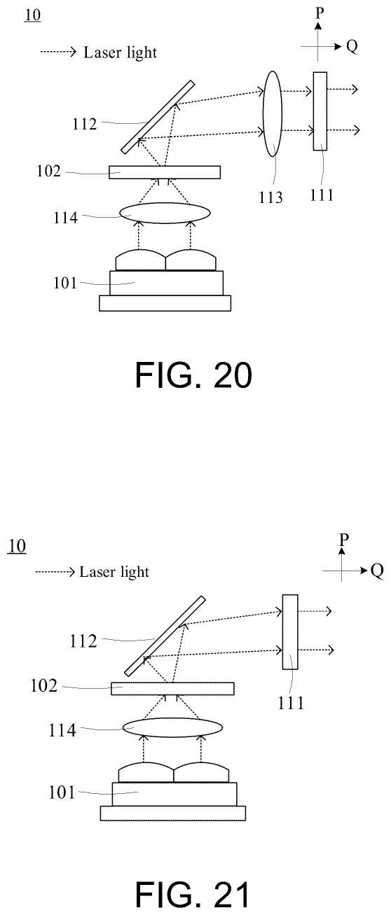

FIG. 17 is a schematic structural view of a light source according to yet other embodiments. The light source 10 in FIG. 13 is based on the light source 10 in FIG. 7 and further includes a second lens 114. FIG. 18 is a schematic structural view of a light source according to yet other embodiments. The light source 10 in FIG. 18 is based on the light source 10 in FIG. 14 and further includes a second lens 114. FIG. 19 is a schematic structural view of a light source according to yet other embodiments. The light source 10 in FIG. 19 is based on the light source 10 in FIG. 15 and further includes a second lens 114. FIG. 20 is a schematic structural view of a light source according to yet other embodiments. The light source 10 in FIG. 20 is based on the light source 10 in FIG. 16 and further includes a second lens 114.

In some embodiments, as shown in FIGS. 17 to 20, the light source 10 further includes the second lens 114. The second lens 114 is located between the laser 101 and the light combining member 102 and is configured to converge the laser light emitted from the laser 101 to the light combining member 102. In this way, the beam of the laser light in the light path can be made thin, thereby reducing the size of the components (e.g., the first lens 113 and the beam reshaping member 111) in the subsequent light path, which facilitates reducing the volume of the light source 10.

FIG. 21 is a schematic structural view of a light source according to yet other embodiments. The light source 10 in FIG. 21 is based on the light source 10 in FIG. 14 and further includes a second lens 114. The principle and effect of the light source 10 including the second lens 114 in FIG. 6, FIG. 9, and FIG. 11 are similar to those in FIG. 21 and are not shown herein again.

It should be noted that, with respect to the first lens 113 and the second lens 114, as shown in FIG. 13 to FIG. 16, the light source 10 in some embodiments of the present disclosure may include only the first lens 113, or as shown in FIG. 21, the light source 10 may include only the second lens 114, or as shown in FIGS. 17 to 20, the light source 10 may include both the first lens 113 and the second lens 114. The first lens 113 and the second lens 114 may each be a convex lens. Alternatively, at least one of the first lens 113 and the second lens 114 may be a Fresnel lens, so as to reduce the volume of the lens and improve the collimation and convergence effect of the lens on the laser light.

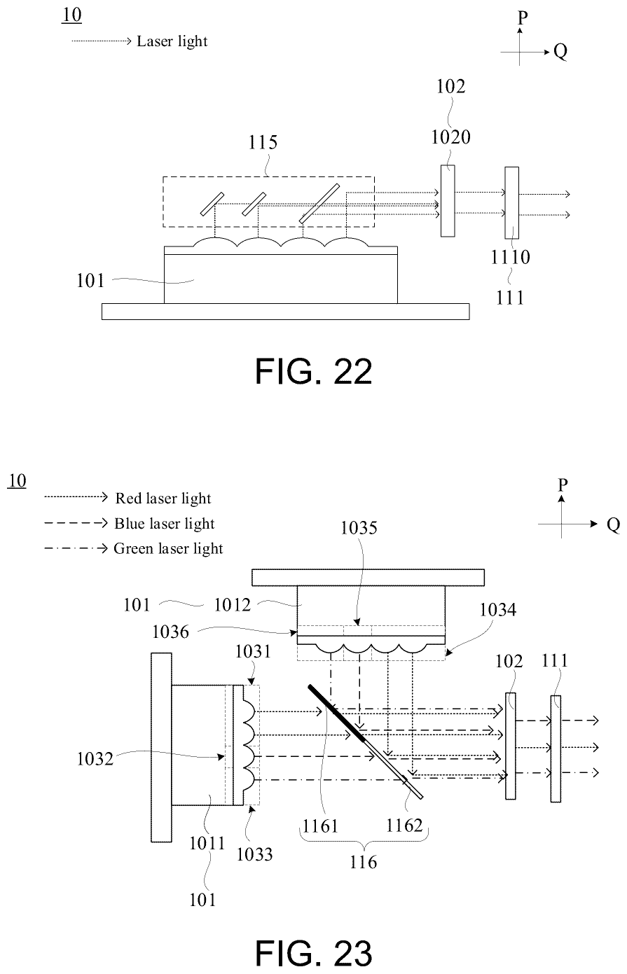

FIG. 22 is a schematic structural view of a light source according to yet other embodiments. The light source 10 in FIG. 22 is based on the light source 10 in FIG. 6 and further includes a second light combining mirror assembly 115. In some embodiments, as shown in FIG. 22, in the case where the light combining member 102 includes a diffractive optical element, the light source 10 further includes a second light combining mirror assembly 115 located between the laser 101 and the light combining member 102. The structure of the second light combining mirror assembly 115 mat refer to the structure of the light combining member 102 in FIG. 7, and details are not described herein again. The second light combining mirror assembly 115 is configured to combine the laser light of the plurality of colors emitted from the laser 101 for a first time and transmit the combined laser light of the plurality of colors to the light combining member 102. After that, the light combining member 102 can combine the laser light of the plurality of colors initially combined by the second light combining lens group 115 for a second time, so as to improve the light combining effect of the laser light of different colors.

In addition, the principle and effect of the light source 10 including the second light combining mirror assembly 115 in FIGS. 11 to 14, 16 to 18, 20 and 21 are similar to those in FIG. 23, and are not shown herein again. It should be noted that, for the light source 10 including the second lens 114, the second light combining mirror assembly 115 may be located between the laser 101 and the second lens 114.

In the foregoing description, the light source 10 includes one laser 101. In some embodiments, the light source 10 may alternatively include a plurality of lasers 101. The plurality of lasers 101 may be the same. For example, the plurality of lasers 101 each emit red laser light, green laser light, and blue laser light. Alternatively, the plurality of lasers 101 may be different. For example, one of the plurality of lasers 101 emits red laser light, green laser light, and blue laser light, and another of the plurality of lasers 101 emits red laser light and blue laser light. The plurality of lasers 101 may alternatively emit laser light of other colors, which is not limited in the present disclosure.

FIG. 23 is a schematic structural view of a light source according to yet other embodiments. In some embodiments, as shown in FIG. 23, the light source 10 includes a third laser 1011 and a fourth laser 1012. The third laser 1011 and the fourth laser 1012 may be the same. For example, the third laser 1011 and the fourth laser 1012 both emit red laser light, green laser light, and blue laser light. The light source 10 further includes a third light combining mirror assembly 116, which is located on a light outgoing side of the third laser 1011 and the fourth laser 1012 and on a light incident side of the light combining member 102. The light combining member 102 may include a diffractive optical element.

The structure of the third light combining mirror assembly 116 may be different from that of the second light combining mirror assembly 115. The third light combining mirror assembly 116 may be plate-shaped, and the third laser 1011 and the fourth laser 1012 are respectively located on opposite sides of the third light combining mirror assembly 116. For example, a side of the third light combining mirror assembly 116 away from the light combining member 102 faces the third laser 1011, and a side of the third light combining mirror assembly 116 adjacent to the light combining member 102 faces the fourth laser 1012.

The third light combining mirror assembly 116 may be a dichroic mirror, and different regions of the third light combining mirror assembly 116 have different dichroics. For example, as shown in FIG. 23, the third light combining mirror assembly 116 includes a first region 1161 and a second region 1162. The first region 1161 is closer to the third laser 1011 than the second region 1162. The first region 1161 is configured to reflect the blue laser light and the green laser light and transmit the red laser light, and the second region 1162 is configured to reflect the red laser light and transmit the blue laser light and the green laser light.

The light outgoing region 1031 emitting the red laser light in the third laser 1011 corresponds to the first region 1161, and the light outgoing region 1032 emitting the blue laser light and the light outgoing region 1033 emitting the green laser light in the third laser 1011 both correspond to the second region 1162. The light outgoing region 1034 emitting the red laser light in the fourth laser 1012 corresponds to the second region 1162, and the light outgoing region 1035 emitting the blue laser light and the light outgoing region 1036 emitting green laser light in the fourth laser 1012 both correspond to the first region 1161. In this way, the red laser light emitted from the third laser 1011 and the blue laser light and the green laser light emitted from the fourth laser 1012 can be respectively emitted from the first region 1161, the blue laser light and the green laser light emitted from the third laser 1011, and the red laser light emitted by the fourth laser 1012 can be respectively emitted from the second region 1162, thereby realizing the first light combination of the laser light of the plurality of colors emitted from the third laser 1011 and the fourth laser 1012 by the third light combining mirror assembly 116.

It should be noted that the illustration of distinguishing the laser light of different colors in FIG. 23 is only used to indicate the colors of the laser light emitted from each member, and positions of the laser light of colors in FIG. 23 do not represent the actual distribution positions of the laser light. For example, the laser light emitted from the light combining member 102 includes red laser light, green laser light, and blue laser light. In FIG. 23, the red laser light is located in the middle region of the light combining member 102, and the blue laser light and the green laser light are respectively located in two side regions of the light combining member 102, which is only used for distinguishing the laser light of the three colors. In actual cases, the red laser light, the green laser light, and the blue laser light may be transmitted out of each region of the light combining member 102, and the laser light of the three colors may be directed to the same region of the beam reshaping member 111.

It should be noted that, in some embodiments of the present disclosure, the description that a certain component is located between two components refers to a positional relationship of the components on a transmission path of the laser light, rather than an intuitive positional relationship in space.

In the foregoing description, the light source 10 includes the diffractive optical element, and the light homogenizing member 210 and the lens assembly 220 are omitted. In some embodiments, the optical modulating assembly 20 may include a volume grating to adjust the illumination beam, thereby omitting the lens assembly 220 and the prism assembly 250 to facilitate miniaturization of the projection device 1000.

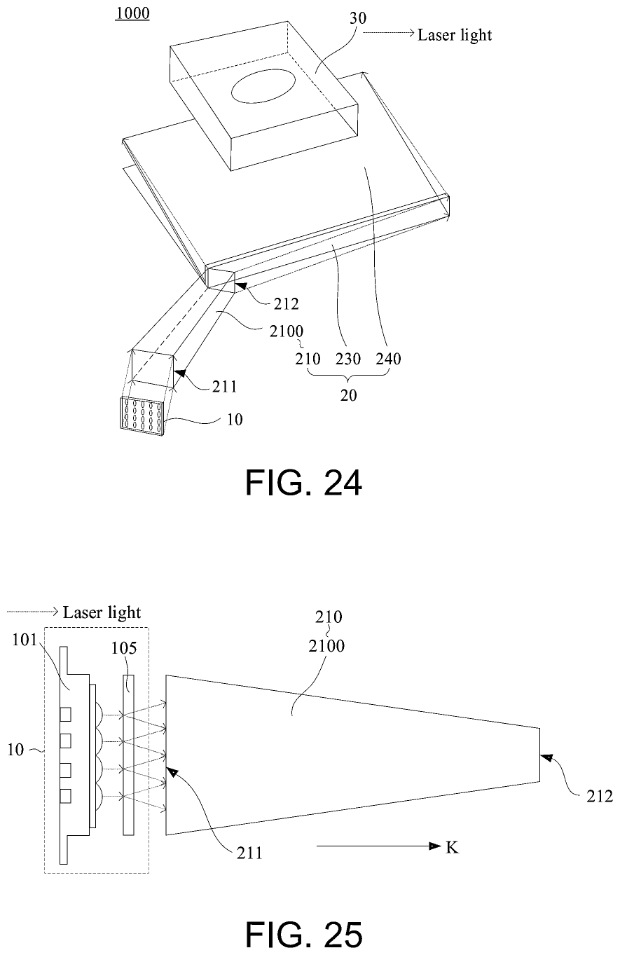

FIG. 24 is a perspective view of a projection device according to other embodiments. FIG. 25 is a diagram showing a light path between a light source and a light guide according to some embodiments, and a side view of the light guide is included in FIG. 25.

As shown in FIG. 24, the projection device 1000 includes a light source 10, an optical modulating assembly 20, and a lens 30. The optical modulating assembly 20 includes a light homogenizing member 210, a volume grating 230, and a light valve 240 (e.g., a DMD).

As shown in FIG. 25, the light homogenizing member 210 includes a wedge-shaped light guide 2100. An area of a cross section of the light guide 2100 decreases along a transmission direction of the illumination beam (e.g., a direction K in FIG. 25). For example, as shown in FIG. 25, the light guide 2100 includes a first end 211 and a second end 212. The first end 211 is adjacent to the light source 10 and is an incident end to receive the illumination beam from the light source 10. The second end 212 is away from the light source 10 and is an outgoing end, and the illumination beam homogenized by the light guide 2100 is transmitted out of the light guide 2100 from the second end 212. An area of a cross section of the first end 211 is greater than an area of a cross section of the second end 212. The cross section of the light guide 2100 may refer to a cross section of the light guide 2100 perpendicular to the transmission direction of the illumination beam.

The wedge-shaped light guide 2100 can directly receive the illumination beam of the light source 10, and the illumination beam may not need to be converged by a converging lens or other structures, which is conducive to simplifying the structure of the projection device 1000 and facilitating the miniaturization of the projection device 1000.

The light homogenizing member 210 may be the wedge-shaped light guide 2100 described above. The illumination beam from the light source 10 enters the light guide 2100 through the first end 211 of the light guide 2100 to be homogenized, and is transmitted from the second end 212 of the light guide 2100 toward the volume grating 230 after being homogenized. The light valve 240 is located on the light outgoing side of the volume grating 230 and is configured to receive an illumination beam from the volume grating 230 and modulate the illumination beam to obtain a projection beam. It should be noted that the relevant contents of the light homogenizing member 210 and the light valve 240 can make reference to the foregoing, and are not described herein again.

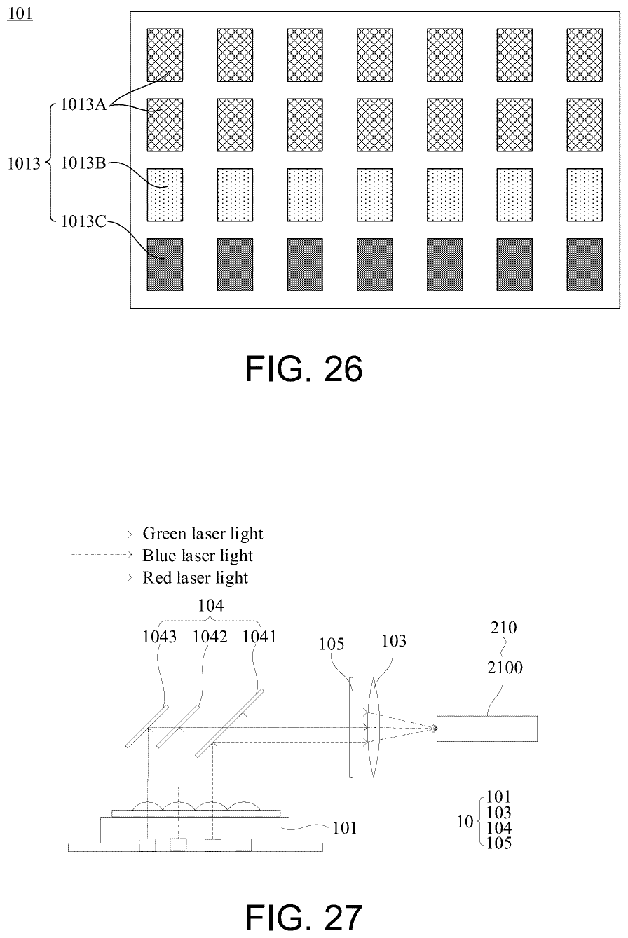

FIG. 26 is a schematic structural view of a laser according to some embodiments.

The structure of the light source 10 will be described below by taking the laser 101 shown in FIG. 26 as an example. It should be noted that the laser 101 in FIG. 26 includes a plurality of light emitting chips 1013 arranged in a matrix array of 4 rows and 7 columns. The plurality of light emitting chips 1013 includes a plurality of first light emitting chips 1013A, a plurality of second light emitting chips 1013B, and a plurality of third light emitting chips 1013C. The plurality of first light emitting chips 1013A emit red laser light and are arranged in a matrix array of 2 rows and 7 columns. The plurality of second light emitting chips 1013B emit blue laser light, the plurality of third light emitting chips 1013C emit green laser light, and the plurality of second light emitting chips 1013B and the plurality of third light emitting chips 1013C are each arranged in a matrix array of 1 row and 7 columns. The number and arrangement of the laser 101 and the plurality of light emitting chips 1013 are not limited thereto. For example, the positions of the plurality of second light emitting chips 1013B and the plurality of third light emitting chips 1013C in FIG. 26 are interchanged.

FIG. 27 is a schematic structural view of a light source according to yet other embodiments.

In some embodiments, as shown in FIG. 27, the light source 10 further includes a first light combining mirror assembly 104. The first light combining mirror assembly 104 is located on a light outgoing side of the plurality of first light emitting chips 1013A, the plurality of second light emitting chips 1013B, and the plurality of third light emitting chips 1013C, and is configured to combine the red laser light, the green laser light, and the blue laser light. The light guide 2100 (the light homogenizing member 210) is located on the light outgoing side of the first light combining mirror assembly 104. The light guide 2100 may be a light guide having the same cross-sectional area.

The first light combining mirror assembly 104 may include a first light combining mirror 1041, a second light combining mirror 1042, and a third light combining mirror 1043. The third light combining mirror 1043 is located on the light outgoing side of the plurality of third light emitting chips 1013C. The third light combining mirror 1043 may be a reflection mirror, and is configured to reflect the green laser light emitted from the plurality of third light emitting chips 1013C to the second light combining mirror 1042.

The second light combining mirror 1042 is located on the light outgoing side of the plurality of second light emitting chips 1013B and on the light outgoing side of the third light combining mirror 1043. For example, the second light combining mirror 1042 is located at the intersection of the light reflected by the third light combining mirror 1043 and the light emitted from the plurality of second light emitting chips 1013B. The second light combining mirror 1042 may be a dichroic mirror, and is configured to transmit the green laser light reflected by the third light combining mirror 1043 and reflect the blue laser light emitted from the plurality of second light emitting chips 1013B, so as to combine the blue laser light and the green laser light.

The first light combining mirror 1041 is located on the light outgoing side of the plurality of first light emitting chips 1013A and on the light outgoing side of the second light combining mirror 1042. For example, the first light combining mirror 1041 is located at the intersection of the light emitted from the plurality of first light emitting chips 1013A and the light transmitted from the second light combining mirror 1042. The first light combining mirror 1041 may be a dichroic mirror, and is configured to transmit the blue laser light and the green laser light transmitted from the second light combining mirror 1042, and to reflect the red laser light emitted from the plurality of first light emitting chips 1013A, so as to combine the blue laser light, the green laser light, and the red laser light. It should be noted that the function of the plurality of light combining mirrors is not limited thereto. For example, in the case where the positions of the plurality of second light emitting chips 1013B and the plurality of third light emitting chips 1013C in FIG. 19 are interchanged, the third light combining mirror 1043 may be configured to reflect the blue laser light, and the second light combining mirror 1042 may be configured to reflect the green laser light and to transmit the blue laser light.

In some embodiments, as shown in FIG. 27, the light source 10 further includes a diffusion sheet 105 and a converging lens 103. The diffusion sheet 105 and the converging lens 103 are located between the first light combining mirror assembly 104 and the light guide 2100. Moreover, the diffusion sheet 105 is located on the light outgoing side of the first light combining mirror assembly 104, and the converging lens 103 is located on the light outgoing side of the diffusion sheet 105. The diffusion sheet 105 is configured to homogenize the light incident thereon, thereby eliminating speckle. The converging lens 103 is configured to converge the laser light, so that more laser light can be incident into the light homogenizing member 210, thereby improving the utilization rate of the laser light.

The volume grating 230 in some embodiments of the present disclosure is described in detail below.

As shown in FIG. 24, the volume grating 230 is located on the light outgoing side of the light homogenizing member 210, and is configured to diffract incident light (e.g., an illumination beam).

The volume grating 230 refers to a diffraction element formed by the entire volume of an element that can modulate incident light by periodically changing the refractive index or periodically absorbing light of a specific wavelength. For example, the volume grating 230 is a grating having a periodic refractive index, also referred to as a volume phase grating, and the refractive index at different portions of the volume grating 230 varies periodically.

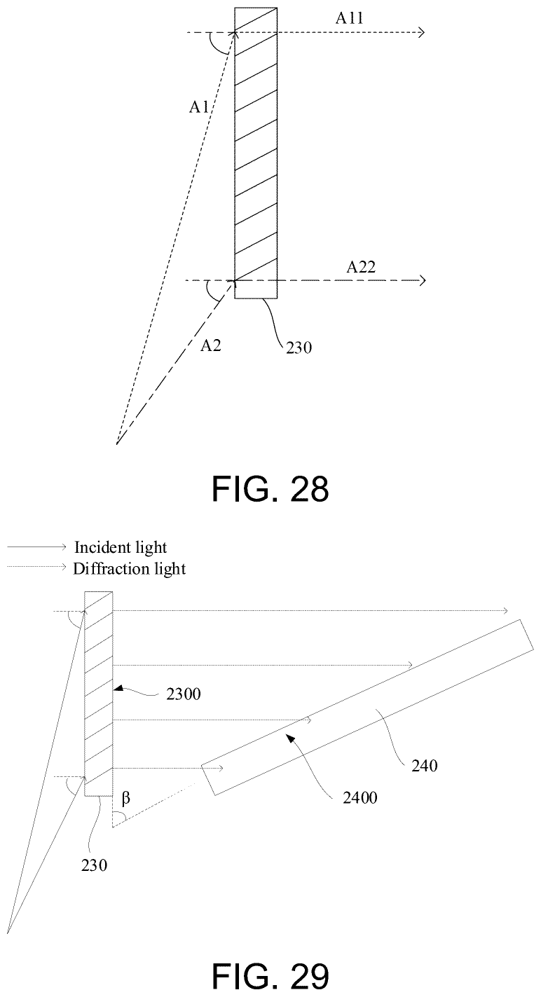

It should be noted that, in general, a light beam can be diffracted after being incident on a thin diffraction grating, and two light beams (i.e., a transmitted light beam and a diffracted light beam) are formed. After the light beam is incident on the volume grating 230 and diffracted, only one light beam is formed. FIG. 28 is a diffraction diagram of a volume grating according to some embodiments. For example, as shown in FIG. 28, a first light beam A1 is incident on the volume grating 230 and diffracted to form a first diffracted light beam A11, and a second light beam A2 is incident on the volume grating 230 and diffracted to form a second diffracted light beam A22.

A diffraction efficiency is a ratio of an optical power of the diffracted light to an optical power of the incident light. When the diffraction efficiency reaches 100%, indicating that all incident light can be diffracted and transmitted. The diffraction efficiency may reach 100% only when the light of a set wavelength is incident on the volume grating 230 at a Bragg angle. When the incident angle or wavelength is deviated, the diffraction efficiency will be reduced or even zero.

Therefore, the volume grating 230 can be designed according to the above properties to obtain a great diffraction efficiency. In general, an incident angle of the light beam incident on the volume grating 230 can be determined, and the incident angle is related to the structure of the projection device 1000 and the divergence angle of the emitting light of the light guide 2100, and the laser light incident on the volume grating 230 can have three wavelength bands (e.g., wavelengths corresponding to the red laser light, the green laser light and the blue laser light). Therefore, when designing the volume grating 230, appropriate refractive index change, thickness and period can be selected according to the wavelength of the incident laser light and the incident angle of the incident laser light incident on the volume grating 230 at different positions, so that the three-color laser light can be completely diffracted after being incident on the volume grating 230 (i.e., the diffraction efficiency corresponding to all incident light is 100%), thereby avoiding crosstalk between light at different angles and different wavelengths and reducing the generation of unnecessary diffraction. The period of the volume grating 230 refers to a length from one refractive index change point to an adjacent refractive index change point in the volume grating 230.

In some embodiments, the volume grating 230 may employ a photopolymer film, for example, a polypropylene (PP) film. The photopolymer can be polymerized under the condition of illumination, so that the refractive index of the material after the reaction is changed. In this way, according to the design requirements of the volume grating 230, different positions of the photopolymer film are illuminated to different degrees to form gradient refractive index changes, so that the volume grating 230 has a relatively high diffraction efficiency for the incident three-color laser.

In some embodiments, the thickness of the volume grating 230 is on the order of wavelength. For example, the thickness of the volume grating 230 is an integer multiple of the wavelength of the laser light of the corresponding color. After the light beam transmitted from the light homogenizing member 210 is incident on the volume grating 230, the volume grating 230 can deflect, homogenize and amplify the light beam, so that the light beam becomes a surface light source with a larger area, and the diffracted light transmitted from the volume grating 230 is substantially parallel light and can be directly incident on the light valve 240. Therefore, compared with the projection device 1000 shown in FIG. 5, by using the volume grating 230, a size of an illumination system in the projection device 1000 can be greatly reduced, the volume of the projection device 1000 can be reduced, and the miniaturization of the projection device 1000 can be facilitated. The illumination system may refer to relevant optical components in the optical modulating assembly 20 for shaping the illumination beam to be adapted to the light valve 240.

In some embodiments, the volume grating 230 is provided on a side of the light valve 240, and a predetermined angle is formed between a light outgoing surface of the volume grating 230 and a light incident surface of the light valve 240. Since the DMD is generally square, the laser light from the light source needs to be incident on the DMD at a predetermined angle. Therefore, the light outgoing surface of the volume grating 230 and the light incident surface of the DMD may be arranged at a predetermined angle.

FIG. 29 is a schematic structural view of a volume grating and a light valve according to some embodiments. For example, as shown in FIG. 29, a predetermined angle β is formed between the light outgoing surface 2300 of the volume grating 230 and the light incident surface 2400 of the light valve 240. Since DMDs of different specifications have different requirements for the incident angle of light, the angle between the volume grating 230 and the DMD needs to be set according to the requirements of the DMD.

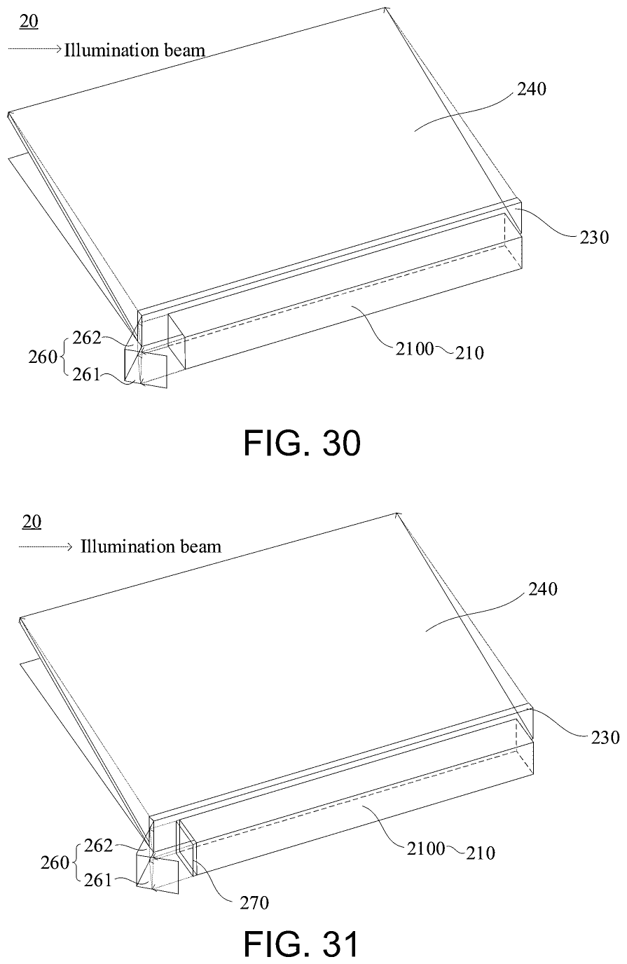

FIG. 30 is a perspective view of an optical modulating assembly in a projection device according to some embodiments. In some embodiments, as shown in FIG. 30, the volume grating 230 is located on a side edge of the light valve 240. The light guide 2100 is located on a side of the volume grating 230 away from the light valve 240, and the light guide 2100 extends in a direction parallel to the side edge of the light valve 240. In this case, the optical modulating assembly 20 further includes a reflection mirror assembly 260. The reflection mirror assembly 260 is provided on the light outgoing side of the light guide 2100, and the reflection mirror assembly 260 is configured to reflect the illumination beam transmitted from the light guide 2100 to the volume grating 230.

The reflection mirror assembly 260 may include one or more first reflection mirrors (mirrors) that may reflect red, green, and blue laser light. For example, as shown in FIG. 22, the reflection mirror assembly 260 includes two mirrors 261, 262 arranged at a predetermined angle therebetween. It should be noted that one, two, or more mirrors may be provided on the light outgoing side of the light guide 2100 according to an actual situation, which is not limited in the present disclosure.

It should be noted that a size and a position of the reflection mirror assembly 260 and an inclination angle of the illumination beam transmitted from the light guide 2100 with respect to the reflection mirror assembly 260 need to satisfy the condition that the illumination beam transmitted from the light guide 2100 is reflected to the light incident surface of the volume grating 230. Therefore, parameters such as the period, the thickness, and the refractive index change of the volume grating 230 can be designed according to the incident angle at which the illumination beam is reflected to the volume grating 230 by the reflection mirror assembly 260.

FIG. 31 is a perspective view of an optical modulating assembly in a projection device according to other embodiments. In some embodiments, as shown in FIG. 31, the optical modulating assembly 20 further includes one or more collimating lenses 270. The collimating lens 270 is located between the light guide 2100 and the reflection mirror assembly 260 and is configured to collimate an incident light beam. For example, the collimating lens 270 is attached to a light outlet of the light guide 2100. After being collimated by the collimating lens 270, the illumination beam transmitted from the light guide 2100 is incident on the reflection mirror assembly 260, and an incident angle of the illumination beam incident on the reflection mirror assembly 260 can be a fixed value, so that the incident angle of the illumination beam reflected by the reflection mirror assembly 260 to the volume grating 230 can also be a fixed value, which is conducive to simplifying the design difficulty of the volume grating 230.

In the case where the optical modulating assembly 20 includes one collimating lens 270, the structure of the optical modulation module 20 is simple, which facilitates miniaturization of the projection device 1000. In addition, by providing the collimating lens 270 at the light outlet of the light guide 2100, the divergence angle of the illumination beam transmitted from the light guide 2100 can be reduced, so as to facilitate determining the incident angle of the illumination beam incident on the volume grating 230.

It should be noted that in some embodiments of the present disclosure, the solution of achieving light homogenization using the volume grating 230 may also be applied to a liquid crystal display device. For example, the solution is applied to a backlight for a liquid crystal display panel.

In the foregoing description, the uniformity of the light spot is mainly adjusted by the diffractive optical element or the volume grating as an example. In some embodiments, the projection device 1000 may also use an optical waveguide (such as an array optical waveguide or a sawtooth-shaped optical waveguide) to adjust the uniformity of the light spots of the laser light of a plurality of colors. The array optical waveguide or the sawtooth-shaped optical waveguide may be in the form of a sheet. For example, the array optical waveguide or the sawtooth-shaped optical waveguide is a transparent substrate with a high refractive index, the illumination beam emitted from the light source is coupled into a side of the substrate through a specific structure, the illumination beam is totally reflected and transmitted in the substrate, and the illumination beam is coupled out through another specific structure after being transmitted to a position.

The light source 10 having an optical waveguide in some embodiments of the present disclosure is described in detail below.

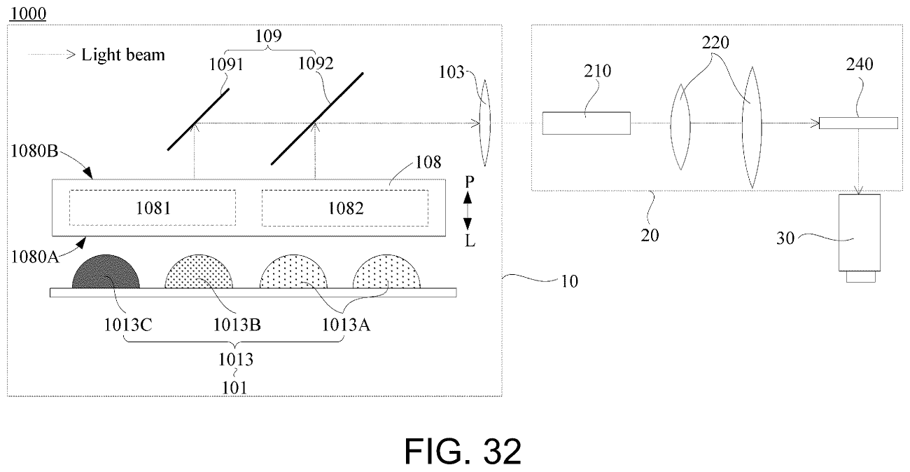

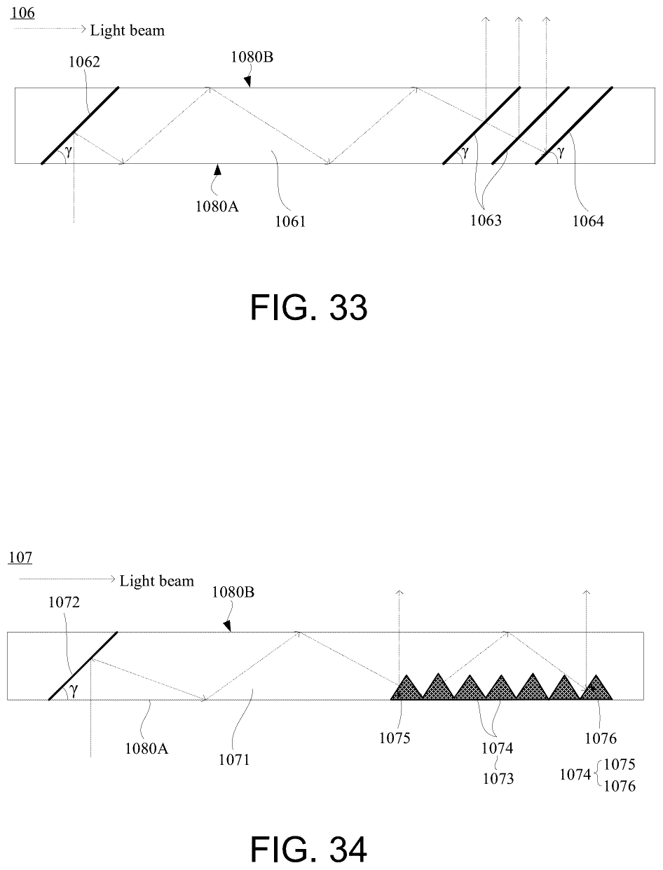

FIG. 32 is a schematic structural view of a projection device according to yet other embodiments. In some embodiments, the light source 10 may include a laser 101 and one or more optical waveguides 108. The laser 101 shown in FIG. 26 is described below as an example.

The optical waveguide 108 may be located on the light outgoing side of the third light emitting chip 1013C. The optical waveguide 108 may include a light incident portion 1081 and a light outgoing portion 1082. The light incident portion 1081 is configured to introduce the laser light (e.g., at least one of the blue laser light or the green laser light) incident thereon into the optical waveguide 108. The light outgoing portion 1082 is configured to transmit the laser light out of the optical waveguide 108. Abeam width of at least one of the blue laser light and the green laser light transmitted from the light outgoing portion 1082 is equal to a beam width of the red laser light emitted from the first light emitting chip 1013A. The beam width may refer to a dimension of the light beam on a plane perpendicular to an axis of the light beam.

The optical waveguide 108 may be made of a material having low optical transparency and transmission loss, such as glass, silicon dioxide, or lithium niobate. In addition, the light incident portion 1081 and the light outgoing portion 1082 of the optical waveguide 108 have a film layer with a reflection or transmission function, so that the light incident into the optical waveguide 108 transmitted in the optical waveguide 108 along a predetermined path.

In some embodiments, as shown in FIG. 32, the optical waveguide 108 includes a light incident surface 1080A and a light outgoing surface 1080B that are parallel to each other, and the light incident surface 1080A and the light outgoing surface 1080B are opposite to each other in a thickness direction (e.g., a direction PL in FIG. 32) of the optical waveguide 108. The light incident portion 1081 and the light outgoing portion 1082 of the optical waveguide 108 are located between the light incident surface 1080A and the light outgoing surface 1080B, respectively. The light incident surface 1080A of the optical waveguide 108 faces the laser 101. It should be noted that the optical modulating assembly 20 in FIG. 32 may be replaced with the above-mentioned optical modulating assembly 20 having the volume grating.

FIG. 33 is a schematic structural view of an array optical waveguide according to some embodiments. FIG. 34 is a schematic structural view of a sawtooth-shaped optical waveguide according to some embodiments. In some embodiments, the optical waveguide 108 may include an array optical waveguide 106 or a sawtooth-shaped optical waveguide 107.

For example, as shown in FIG. 33, the array optical waveguide 106 includes a first body 1061, a first reflection film 1062, one or more first transflective films 1063, and a second reflection film 1064. The first reflection film 1062, the first transflective film 1063, and the second reflection film 1064 are provided in the first body 1061. The first reflection film 1062 is located at one end of the first body 1061 to serve as a light incident portion of the array optical waveguide 106 (i.e., the light incident portion 1081 of the optical waveguide 108). The first transflective film 1063 and the second reflection film 1064 are located at the other end of the first body 1061 to serve as a light outgoing portion of the array optical waveguide 106 (i.e., the light outgoing portion 1082 of the optical waveguide 108). The first transflective film 1063 is located between the first reflection film 1062 and the second reflection film 1064.

The first reflection film 1062, the first transflective film 1063, and the second reflection film 1064 are parallel to each other, and are inclined at a predetermined angle γ with respect to the light incident surface 1080A of the optical waveguide 108. The predetermined angle γ is configured such that the laser light incident into the optical waveguide is reflected and is totally reflected in the first body 1061.

The light beam incident on the light incident portion of the array optical waveguide 106 is reflected by the first reflection film 1062 and then is totally reflected multiple times in the first body 1061 to be transmitted. When the light beam passes through the first transflective film 1063, the first transflective film 1063 may reflect a first part of the light beam out of the array optical waveguide 106, and transmit a second part of the light beam to the next first transflective film 1063, until the light beam is transmitted to the second reflection film 1064, the second reflection film 1064 reflects all of the remaining light beams out of the array optical waveguide 106. It should be noted that the transmissivity and reflectivity of the light incident on first transflective film 1063 can be changed by coating the first transflective film 1063, and the light beams that can be transmitted and reflected by the second transflective film 1064 can be changed by coating the second reflection film 1064.

By arranging a plurality of film layers in the array optical waveguide 106, the light beam in the array optical waveguide 106 can be divided into different parts to be transmitted, thereby expanding the light beam. In addition, by adjusting the number and positions of the first transflective films 1063 in the array optical waveguide 106, the size of the light beam (e.g., the beam width) transmitted from the array optical waveguide 106 can be adjusted. In addition, in the case where the array optical waveguide 106 includes a plurality of first transflective films 1063, by adjusting the reflectivity and transmissivity of the plurality of first transflective films 1063, light beams can be reflected multiple times in the array optical waveguide 106, and the uniformity of light beams transmitted from the array optical waveguide 106 can be improved.

For example, as shown in FIG. 34, the sawtooth-shaped optical waveguide 107 includes a second body 1071, a third reflection film 1072, and a prism portion 1073. The third reflection film 1072 and the prism portion 1073 are provided in the second body 1071. The third reflection film 1072 is located at one end of the second body 1071 to serve as a light incident portion of the sawtooth-shaped optical waveguide 107 (i.e., the light incident portion 1081 of the optical waveguide 108). The prism portion 1073 is located at the other end of the second body 1071 to serve as a light outgoing portion of the sawtooth-shaped optical waveguide 107 (i.e., the light outgoing portion 1082 of the optical waveguide 108).

The third reflection film 1072 is spaced apart from the prism portion 1073 by a predetermined distance, so as to allow the prism portion 1073 to transmit and reflect the laser light of the corresponding wavelength. The third reflection film 1072 is inclined at the predetermined angle 7 with respect to the light incident surface 1080A of the optical waveguide 108. The predetermined angle 7 is configured such that the incident laser light is reflected and the laser light is totally reflected in the second body 1071.

The prism portion 1073 is located on the light incident surface 1080A of the optical waveguide 108. The prism portion 1073 may include a plurality of sub-prisms 1074 arranged in parallel. Each sub-prism 1074 may be strip-shaped. The plurality of sub-prisms 1074 include two or more sub-prisms 1074 adjacent to the third reflection film 1072, a second transflective film 1075 is provided on a surface of the sub-prism 1074 facing the third reflection film 1072. The plurality of sub-prisms 1074 include one or more sub-prisms 1074 away from the third reflection film 1072, a fourth reflection film 1076 is provided on the surface of the sub-prism 1074 facing the third reflection film 1072. The number of the second transflective film 1075 and the fourth reflection film 1076 may be set according to actual needs.

The light beam incident on the light incident portion of the sawtooth-shaped optical waveguide 107 is reflected by the third reflection film 1072 and then is totally reflected multiple times in the second body 1071 to be transmitted. When the light beam passes through the second transflective film 1075 in the prism portion 1073, the second transflective t film 1075 may reflect a first part of the light beam out of the sawtooth-shaped optical waveguide 107, and transmit a second part of the light beam to the next second transflective film 1075, until the light beam is transmitted to the fourth reflection film 1076 and is reflected out of the sawtooth-shaped optical waveguide 107 by the fourth reflection film 1076.

By providing a plurality of film layers in the sawtooth-shaped optical waveguide 107, the light spot of the light beam transmitted from the sawtooth-shaped optical waveguide 107 can be expanded to the same width as the prism portion 1073, and the light beam can be homogenized.

By applying the array optical waveguide 106 and the sawtooth-shaped optical waveguide 107 to the projection device 1000, the laser light of different colors emitted from the light source 10 can be uniformly distributed, thereby improving the display effect of the projection image.

In some embodiments, the light source 10 may include an optical waveguide 108 located on the light outgoing side of the plurality of third light emitting chips 1013C. The optical waveguide 108 is configured to expand the beam width of the green laser light emitted from the third light emitting chip 1013C, so that the beam width of the green laser light transmitted from the light outgoing portion 1082 of the optical waveguide 108 is equal to the beam width of the red laser light emitted from the plurality of first light emitting chips 1013A.

The product of the size of the light spot and the divergence angle of the laser light determines the etendue of the laser light. For example, the smaller the beam width of the laser light, the smaller the etendue of the laser light. In addition, since the small etendue will lead to serious laser speckle phenomenon, and the etendue of the red laser light in the three-color laser projection device is usually greater than that of the blue laser light and the green laser light, the speckle phenomenon of the blue laser light and the green laser light is more obvious than that of the red laser light.

However, in some embodiments of the present disclosure, since the human eye is less sensitive to blue light, outgoing light can be uniform by making the beam widths of the green laser light and the red laser light the same. Further, by increasing the beam width of the green laser light, the etendue of the green laser light can be increased, so that the etendue of the green laser light is the same as the etendue of the red laser light, thereby reducing the speckle phenomenon of the green laser light. In this way, a better display effect can be achieved by using fewer optical components, and the miniaturization of the projection device 1000 is facilitated.

In some embodiments, as shown in FIG. 25, the light source 10 further includes an optical waveguide light combining mirror assembly 109. The optical waveguide light combining mirror assembly 109 is located on the light outgoing side of the laser 101 and the optical waveguide 108, and is configured to combine the red laser light, the green laser light and the blue laser light. The combined light beam can have good uniformity. For example, the optical waveguide light combining mirror assembly 109 includes one or more reflection mirrors and one or more dichroic mirrors. The optical waveguide light combining mirror assembly 109 may also be set according to specific light combining requirements.

In some embodiments, as shown in FIG. 32, the light source 10 further includes a light homogenizing member 210. The light homogenizing member 210 may be located on the light outgoing side of the optical waveguide light combining mirror assembly 109, and is configured to homogenize the laser light combined by the optical waveguide light combining mirror assembly 109, so as to make the energy distribution of the laser light is uniform and reduce the speckle. The related contents of the light homogenizing member 210 can make reference to the foregoing, and are not described herein again.

In some embodiments, as shown in FIG. 32, the light source further includes a converging lens 103 disposed on the light outgoing side of the optical waveguide light combining mirror assembly 109 and configured to converge the incident light beam. The relevant contents of the converging lens 103 may make reference to the foregoing, and are not described herein again.

Several examples of light source 10 include one optical waveguide 108 in some embodiments of that present disclosure are described in detail below.

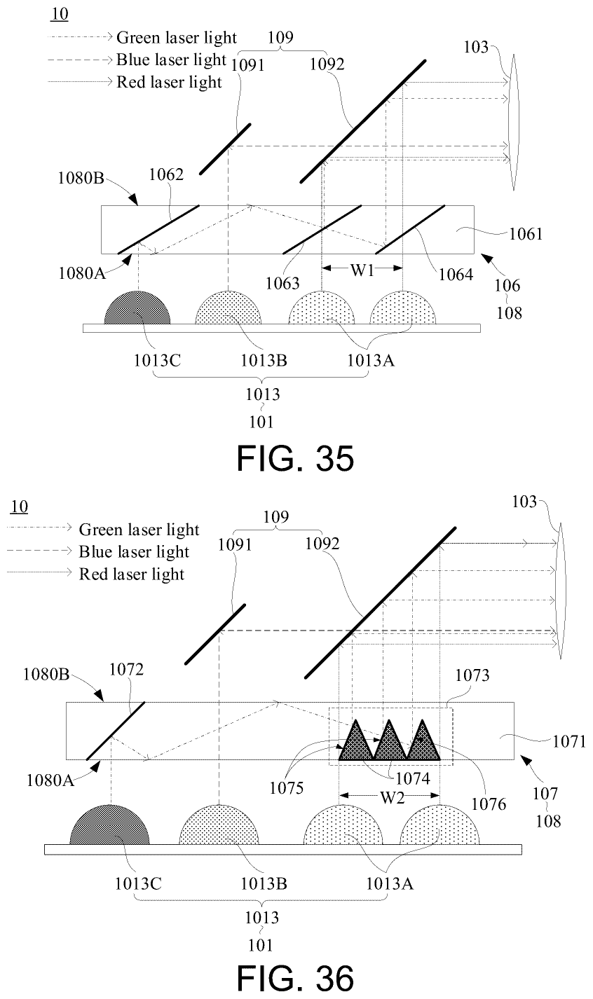

FIG. 35 is a light path diagram of a light source according to yet other embodiments. In some embodiments, as shown in FIG. 35, in the case where the optical waveguide 108 includes the array optical waveguide 106, the first reflection film 1062 is located on the light outgoing side of the third light emitting chip 1013C, and the first transflective film 1063 and the second reflection film 1064 are located on the light outgoing side of the first light emitting chip 1013A. The first transflective film 1063 is configured to reflect a first part of the green laser light and transmit a second part of the green laser light and the red laser light. The second reflection film 1064 is configured to reflect the green laser light and transmit the red laser light. The second reflection film 1064 servers as a dichroic mirror. A distance W1 between the first transflective film 1063 and the second reflection film 1064 is equal to the beam width of the red laser light emitted from the plurality of first light emitting chips 1013A. The beam width of the red laser light equal to the distance W1 may be understood as a corresponding dimension of the red laser light in the same direction as the distance W1, but is not limited thereto.

Referring to FIG. 35, the green laser light emitted from the third light emitting chip 1013C is incident on the first reflection film 1062. Since the inclination angle of the first reflection film 1062 with respect to the light incident surface 1080A satisfies the total reflection condition, after the green laser light is reflected to the light incident surface 1080A by the first reflection film 1062, the green laser light may be totally reflected multiple times between the light incident surface 1080A and the light outgoing surface 1080B in the first body 1061 and be incident on the first transflective film 1063. A first part of the green laser light is reflected out of the array optical waveguide 106 by the first transflective film 1063, and a second part of the green laser light is transmitted by the transflective film 1063 and continues to be transmitted in the first body 1061 until it is incident on the second reflection film 1064. The second reflection film 1064 reflects all of the incident green laser light out of the array optical waveguide 106.

In this case, the optical waveguide light combining mirror assembly 109 may include a fourth light combining mirror 1091 and a fifth light combining mirror 1092. The fourth light combining mirror 1091 is located on the light outgoing side of the plurality of second light emitting chips 1013B, and is configured to reflect the blue laser light. The fifth light combining mirror 1092 is located on the light outgoing side of the array optical waveguide 106, and is configured to reflect the red laser light and the green laser light and transmit the blue laser light. The fourth light combining mirror 1091 and the fifth light combining mirror 1092 are arranged in parallel, and the two may be inclined by a preset angle with respect to a plane where the optical waveguide 108 is located.

In this way, the green laser light transmitted from the array optical waveguide 106 can be reflected to the converging lens 103 by the fifth light combining mirror 1092. The blue laser light emitted from the plurality of second light emitting chips 1013B can be directly transmitted by the array optical waveguide 106 and then incident to the fourth light combining mirror 1091, and reflected to the fifth light combining mirror 1092 by the fourth light combining mirror 1091. The blue laser light reflected to the fifth light combining mirror 1092 is transmitted to the converging lens 103 by the fifth light combining mirror 1092. The red laser light emitted from the plurality of first light emitting chips 1013A is transmitted by the array optical waveguide 106 to the fifth light combining mirror 1092, and is reflected by the fifth light combining mirror 1092 to the converging lens 103. The red, green, and blue laser light incident on the converging lens 103 are converged by the converging lens 103 to the light homogenizing member 210.

In some embodiments of the present disclosure, since the first transflective film 1063 and the second reflection film 1064 are respectively provided on the light outgoing sides of the two rows of first light emitting chips 1013A, and the green laser light is divided into two parts by the first transflective film 1063 and the second reflection film 1064 to be transmitted out of the array optical waveguide 106. Therefore, the beam width of the green laser light transmitted from the array optical waveguide 106 can be increased, and can be equal to the distance W1 between the first transflective film 1063 and the second reflection film 1064. In addition, since the first transflective film 1063 and the second reflection film 1064 may transmit the red laser light, the beam width of the red laser light emitted from the plurality of first light emitting chips 1013A may be equal to the distance W1 between the first transflective film 1063 and the second reflection film 1064. Therefore, the beam width of the green laser light may be equal to the beam width of the red laser light. Thus, the light beam emitted from the light source 10 is more uniform, and the etendue of the green laser light can be increased to be the same as the etendue of the red laser light, thereby reducing the speckle phenomenon of the green laser light.

It should be noted that the transmittance and the reflectance of the first transflective film 1063 can be changed according to the design requirements of the projection device 1000. In some embodiments, the transmittance of the first transflective film 1063 may be 50%, and the reflectance of the first transflective film 1063 may be 50%, so that the energy of the light beam of the green laser light transmitted from the first transflective film 1063 and the second reflection film 1064 is equal, thereby improving the uniformity of the light intensity distribution of the green laser light.

FIG. 36 is a light path diagram of a light source according to yet other embodiments. In other examples, as shown in FIG. 36, in the case where the optical waveguide 108 includes the sawtooth-shaped optical waveguide 107, the third reflection film 1072 is located on the light outgoing side of the plurality of third light emitting chips 1013C, and the prism portion 1073 is located on the light outgoing side of the first light emitting chip 1013A. The second transflective film 1075 is configured to reflect a first part of the green laser light and transmit a second part of the green laser light and the red laser light. A fourth reflection film 1076 is provided on a surface of the sub-prism 1074 that is farthest from the third reflection film 1072 and faces the third reflection film 1072, and is configured to reflect the green laser light and transmit the red laser light. The fourth reflection film 1076 servers as a dichroic mirror. The fourth reflection film 1076 can reflect all the light beams transmitted in the sawtooth-shaped optical waveguide 107 out of the sawtooth-shaped optical waveguide 107, thereby avoiding the loss of the light beam in the case of expanding the light beam. A width W2 of the prism portion 1073 is equal to the beam width of the red laser light emitted from the plurality of first light emitting chips 1013A.

Referring to FIG. 36, the green laser light emitted from the plurality of third light emitting chips 1013C are incident on the third reflection film 1072. Since the inclination angle of the third reflection film 1072 with respect to the light incident surface 1080A satisfies the total reflection condition, after the green laser light is reflected to the light incident surface 1080A by the third reflection film 1072, the green laser light can be totally reflected multiple times between the light incident surface 1080 A and the light-out surface 1080B in the second body 1071 and incident on the prism portion 1073. When the green laser light passes through the second transflective film 1075 on the sub-prism 1074, a first part of the green laser light may be reflected out of the sawtooth-shaped optical waveguide 107 by the second transflective film 1075, and a second part of the green laser light may be transmitted by the second transflective film 1075 and continue to be transmitted to the next sub-prism 1074. After repeating the above process for multiple times, the remaining green laser light is totally reflected out of the sawtooth-shaped optical waveguide by the fourth reflection film 1076.

In this case, the optical waveguide light combining mirror assembly 109 may include a fourth light combining mirror 1091 and a fifth light combining mirror 1092. The structure and function of the optical waveguide light combining mirror assembly 109 are similar to the structure and function of the optical waveguide light combining mirror assembly 109 in FIG. 28, and are not described herein again.

Since the green laser light emitted from the plurality of third light emitting chips 101C is divided into a plurality of parts in the sawtooth-shaped optical waveguide 107 to be transmitted out of the sawtooth-shaped optical waveguide 107. Therefore, the beam width of the green laser light transmitted from the sawtooth-shaped optical waveguide 107 is increased, and can be equal to the width W2 of the prism portion 1073. Since the width of the prism portion 1073 is equal to the beam width of the red laser light emitted from the plurality of first light emitting chips 1013A, the beam widths of the green laser light and the red laser light may be equal. Thus, the light formed by the green laser light and the red laser light being combined by the optical waveguide light combining mirror assembly 109 is relatively uniform, and the etendue of the green laser light can be increased to be the same as the etendue of the red laser light, so as to reduce the speckle phenomenon of the green laser light.

In some embodiments, the light source 10 may also include two optical waveguides 108.

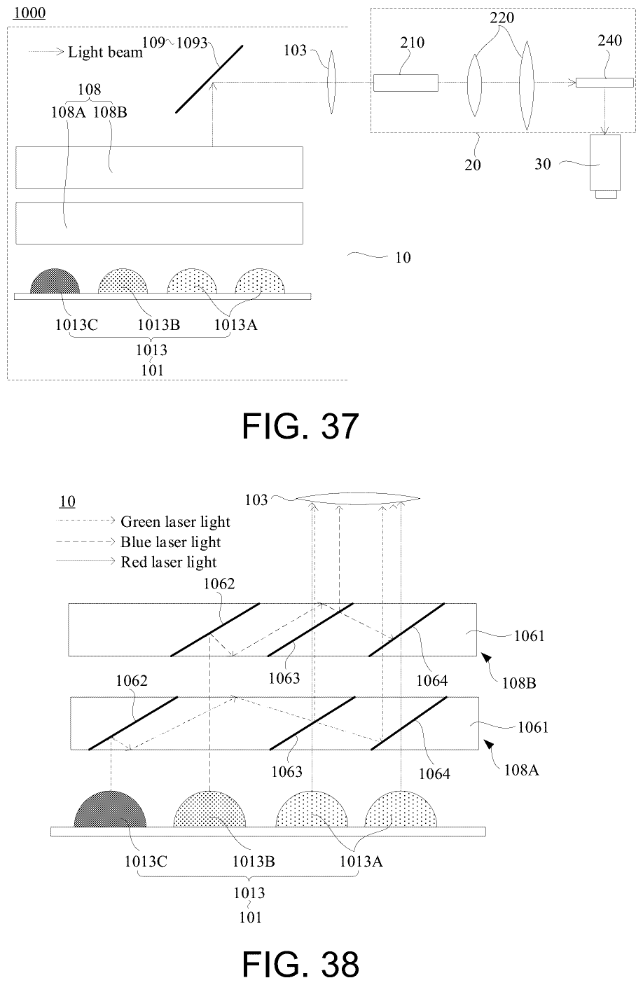

FIG. 37 is a schematic structural view of a projection device according to yet other embodiments. For example, as shown in FIG. 37, the light source 10 includes a first optical waveguide 108A and a second optical waveguide 108B. The first optical waveguide 108A is located on the light outgoing side of the plurality of third light emitting chips 1013C, and the second optical waveguide 108B is located on the light outgoing side of the plurality of second light emitting chips 1013B. The first optical waveguide 108A is configured to expand the beam width of the green laser light emitted from the plurality of third light emitting chips 1013C, and the second optical waveguide 108B is configured to expand the beam width of the blue laser light emitted from the plurality of second light emitting chips 1013B, so that the beam width of the green laser light transmitted from the first optical waveguide 108A and the beam width of the blue laser light transmitted from the second optical waveguide 108B are equal to the beam width of the red laser light emitted from the plurality of first light emitting chips 1013 A.

A configuration in which two optical waveguides 108 are provided in the projection device 1000 can be used in the case where the number of the second light emitting chips 1013B (such as the blue light emitting chips) in the laser 101 is small, so as to enlarge the beam widths of the blue and green laser light to be the same as the beam width of the red laser light, so that the light beam emitted from the light source 10 is uniformly distributed, and the problem that the color temperature and the color condition of a projection picture are abnormal due to the small beam width of the blue laser light can be avoided. In addition, the etendue of the blue laser light and the green laser light can be increased to be the same as the etendue of the red laser light, respectively, thereby reducing the speckle of the blue laser light and the green laser light.

The first optical waveguide 108 A and the second optical waveguide 108B may each be the array optical waveguide 106. Alternatively, the first optical waveguide 108 A and the second optical waveguide 108B may each be the sawtooth-shaped optical waveguide 107. Alternatively, the first optical waveguide 108A is the array optical waveguide 106, and the second optical waveguide 108B is the sawtooth-shaped optical waveguide 107. Alternatively, the first optical waveguide 108A is the sawtooth-shaped optical waveguide 107, and the second optical waveguide 108B is the array optical waveguide 106. The above four manners can expand the beam width of the blue laser and the green laser. Hereinafter, the first optical waveguide 108A and the second optical waveguide 108B are respectively described using the array optical waveguide 106 as an example.

FIG. 38 is a light path diagram of a light source according to yet other embodiments. In some examples, as shown in FIG. 38, the first reflection film 1062 of the first optical waveguide 108A is located on the light outgoing side of the plurality of third light emitting chips 1013C, and the first transflective film 1063 and the second reflection film 1064 of the first optical waveguide 108A are located on the light outgoing side of the plurality of first light emitting chips 1013A. The structure and function of the plurality of film layers in the first optical waveguide 108A, can make reference to the related contents of the array optical waveguide 106 in FIG. 28, and are not described herein again.

The first reflection film 1062 of the second optical waveguide 108B is located on the light outgoing side of the plurality of second light emitting chips 1013B, and is configured to reflect the blue laser light emitted from the plurality of second light emitting chips 1013B. The first transflective film 1063 and the second reflection film 1064 of the second optical waveguide 108B are located on the light outgoing side of the plurality of first light emitting chips 1013A. The first transflective film 1063 of the second optical waveguide 108B is configured to reflect a first part of the blue laser light and transmit a second part of the blue laser light, the green laser light, and the red laser light. The second reflection film 1064 of the second optical waveguide 108B is configured to reflect the blue laser light and transmit the green laser light and the red laser light.

The first transflective film 1063 and the second reflection film 1064 of the second optical waveguide 108B server as a dichroic mirror. The angles of the plurality of film layers in the second optical waveguide 108B can make reference to the foregoing description, and are not described herein again.

A distance between the first transflective film 1063 and the second reflection film 1064 in the first optical waveguide 108A, and a distance between the first transflective film 1063 and the second reflection film 1064 in the second optical waveguide 108B are equal to the beam width of the red laser light emitted from the plurality of first light emitting chips 1013A, respectively. In addition, the first transflective film 1063 in the first optical waveguide 108a may be parallel to the first transflective film 1063 in the second optical waveguide 108B, and the second reflection film 1064 in the first optical waveguide 108A may be parallel to the second reflection film 1064 in the second optical waveguide 108B.

The green laser light emitted from the plurality of third light emitting chips 1013C is incident on the first reflection film 1062 in the first optical waveguide 108A and is reflected by the first reflection film 1062. The green laser light reflected by the first reflection film 1062 is totally reflected multiple times in the first optical waveguide 108A, and is incident on the first transflective film 1063 in the first optical waveguide 108A. A first part of the green laser light is reflected out of the first optical waveguide 108A by the first transflective film 1063, and a second part of the green laser light is transmitted by the first transflective film 1063 and continues to be transmitted in the first optical waveguide 108A until it is incident on the second reflection film 1064 in the first optical waveguide 108A. The green laser light incident on the second reflection film 1064 is totally reflected out of the first optical waveguide 108A by the second reflection film 1064, and the beam width of the green laser light transmitted from the first optical waveguide 108A is equal to the beam width of the red laser light.

The blue laser light emitted from the plurality of second light emitting chips 1013B passes through the first optical waveguide 108A and is incident on the first reflection film 1062 in the second optical waveguide 108B, and is reflected by the first reflection film 1062. The blue laser light reflected by the first reflection film 1062 is totally reflected multiple times in the second optical waveguide 108B, and is incident on the first transflective film 1063 in the second optical waveguide 108B. A first part of the blue laser light is reflected out of the second optical waveguide 108B by the first transflective film 1063, and a second part of the blue laser light is transmitted by the first transflective film 1063 and continues to be transmitted in the second optical waveguide 108B until it is incident on the second reflection film 1064 in the second optical waveguide 108B. The blue laser light incident on the second reflection film 1064 is totally reflected out of the second optical waveguide 108B by the second reflection film 1064, and the beam width of the blue laser light transmitted from the second optical waveguide 108B is equal to the beam width of the red laser light.

The green laser light and the red laser light transmitted from the first optical waveguide 108a may be incident on the converging lens 103 through the second optical waveguide 108B, and the blue laser light and the red laser light transmitted from the second optical waveguide 108B may be directly incident on the converging lens 103.

In this way, by providing the two optical waveguides 108 in the projection device 1000, the beam widths of the red, green, and blue laser light can be equal, so that the color distribution of the light beams emitted from the light source 10 is uniform. In addition, the light beams can be directly converged by one converging lens 103 without arranging the optical waveguide light combining mirror assembly 109 for combining the light beams, which is conducive to simplifying the internal structure of the projection device 1000 and achieving low-cost and lightweight design.

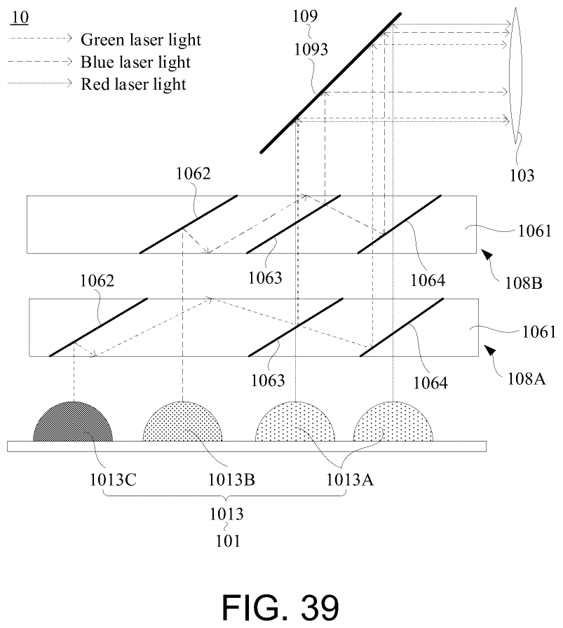

FIG. 39 is a light path diagram of a light source according to yet other embodiments. In other embodiments, the light source 10 in FIG. 38 may also include the optical waveguide light combining mirror assembly 109. For example, as shown in FIG. 39, the light source 10 further includes the optical waveguide light combining mirror assembly 109, the optical waveguide light combining mirror assembly 109 includes a sixth light combining mirror 1093 configured to reflect the green laser light and the red laser light transmitted from the first optical waveguide 108A and the blue laser light and the red laser light transmitted from the second optical waveguide 108B in the same direction to achieve beam combination. For example, the sixth light combining mirror 1093 reflects the incident laser light of three colors toward the converging lens 103. By providing the sixth light combining mirror 1093, the laser light in the light source 10 can be turned to facilitate the display of the projection image, so that the projection device 1000 can be applied to more realistic scenes.

The structures and functions of the laser 101, the first optical waveguide 108A, and the second optical waveguide 108B can make reference to the relevant description in FIG. 38, and are not described herein again.

As described above, the light source 10 includes one laser 101, the laser 101 includes the plurality of first light emitting chips 1013A, the plurality of second light emitting chips 1013B, and the plurality of third light emitting chips 1013 C, and one or more optical waveguides 108 are located on the light outgoing side of the laser 101. In some embodiments, the light source 10 may alternatively include a plurality of lasers 101.

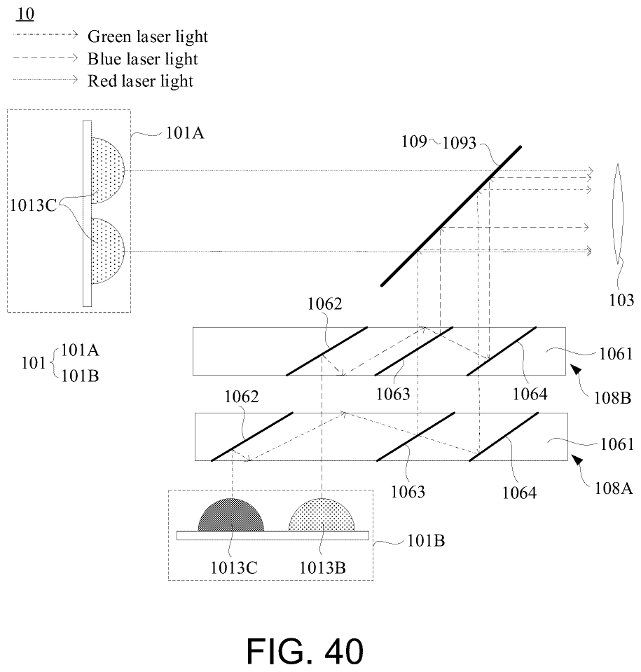

FIG. 40 is a light path diagram of a light source according to yet other embodiments. In some examples, as shown in FIG. 40, the plurality of lasers 101 includes a first laser 101A and a second laser 101B. The first laser 101A includes one or more first light emitting chips 1013A, and the second laser 101B includes one or more second light emitting chips 1013B and one or more third light emitting chips 1013C. The first optical waveguide 108A and the second optical waveguide 108B are located on a light outgoing side of the second laser 101B, and the second optical waveguide 108B is located on a side of the first optical waveguide 108A away from the second laser 101B. For example, as shown in FIG. 33, the first optical waveguide 108A is located on the light outgoing side of the plurality of third light emitting chips 1013C, and the second optical waveguide 108B is located on the light outgoing side of the plurality of second light emitting chips 1013B. The first optical waveguide 108A is configured to expand the beam width of the green laser light emitted from the plurality of third light emitting chips 1013C, and the second optical waveguide 108B is configured to expand the beam width of the blue laser light emitted from the plurality of second light emitting chips 1013B. In the first optical waveguide 108A, a distance between the first transflective film 1063 and the second reflection film 1064 is equal to the beam width of the red laser light emitted from the plurality of first light emitting chips 1013A in the first laser 101A. In the second optical waveguide 108B, a distance between the first transflective film 1063 and the second reflection film 1064 is equal to the beam width of the red laser light emitted from the plurality of first light emitting chips 1013A in the first laser 101A.

In this case, the light source 10 further includes a optical waveguide light combining mirror assembly 109, the optical waveguide light combining mirror assembly 109 includes a sixth light combining mirror 1093 configured to reflect the blue laser light and the green laser light and transmit the red laser light.

The red laser light emitted from the plurality of first light emitting chips 1013A in the first laser 101A is transmitted to the converging lens 103 through the sixth light combining mirror 1093. The green laser light emitted from the plurality of third light emitting chips 1013C in the second laser 101B is expanded to the same beam width as the red laser light through the first optical waveguide 108A, and the blue laser light emitted from the plurality of second light emitting chips 1013B in the second laser 101B is expanded to the same beam width as the red laser light through the second optical waveguide 108B. The green laser light and the blue laser light are respectively reflected by the sixth light combining mirror 1093 to the converging lens 103, and the converging lens 103 converges the red, green and blue laser light.

A configuration in which the light source 10 includes two lasers 101 may also be used in the laser 101 shown in FIG. 26. In this way, the configuration in which the light source 101 includes two lasers 101 can be applied to the case in which the lasers 101 include different numbers of light emitting chips of three colors. It should be noted that the two lasers 101 in FIG. 33 may also correspond to only one optical waveguide 108, and the structure and function of the optical waveguide 108 can make reference to the related description above, and are not described herein again.

In the description of the above embodiments, specific features, structures, materials, or characteristics may be combined in a suitable manner in any one or more embodiments or examples.

Those skilled in the art should understand that the foregoing descriptions are not intended to limit the protection scope of the present disclosure. Any variation or replacement readily figured out by a person skilled in the art within the technical scope disclosed in the present disclosure shall all fall within the protection scope of the present disclosure. The protection scope of the present disclosure shall be subject to the protection scope of the appended claims.

What is claimed is:

1. A projection device, comprising:
a light source configured to emit laser light of a plurality of colors as an illumination beam;
an optical modulating assembly configured to modulate the illumination beam to obtain a projection beam; and
a lens located on a light outgoing side of the optical modulating assembly and configured to project the projection beam to form a projection image;
wherein the light source comprises:
at least one laser, the at least one laser comprising:
a plurality of first light emitting chips configured to emit red laser light;
a plurality of second light emitting chips configured to emit blue laser light; and
a plurality of third light emitting chips configured to emit green laser light, a number of the plurality of third light emitting chips and a number of the plurality of second light emitting chips being smaller than a number of the plurality of first light emitting chips, respectively; and
at least one optical waveguide, wherein one of the at least one optical waveguide is located on a light outgoing side of the plurality of third light emitting chips, and each optical waveguide comprises:
a light incident surface being a surface of the optical waveguide adjacent to the laser;
a light outgoing surface parallel to the light incident surface, the light incident surface and the light outgoing surface being opposite to each other in a thickness direction of the optical waveguide;
a light incident portion configured to introduce the laser light incident thereon into the optical waveguide; and
a light outgoing portion configured to transmit the laser light out of the optical waveguide, wherein the light incident portion and the light outgoing portion are located between the light incident surface and the light outgoing surface, and a beam width of the laser light emitted from the light outgoing portion is equal to a beam width of the red laser light emitted from the plurality of first light emitting chips.

2. The projection device according to claim 1, wherein the optical waveguide comprises an array optical waveguide, and the array optical waveguide comprises:
a first body;
a first reflection film provided in the first body and located at one end of the first body, the first reflection film being configured to reflect the laser light incident on the first reflection film;
a first transflective film provided in the first body and located at the other end of the first body, the first transflective film being configured to reflect a first part of the laser light from the first reflection film and transmit a second part of the laser light from the first reflection film; and
a second reflection film provided in the first body and located at the other end of the first body, the first transflective film being located between the first reflection film and the second reflection film, the second reflection film being configured to at least reflect the laser light transmitted by the first transflective film;
wherein the first reflection film constitutes the light incident portion, the first transflective film and the second reflection film constitute the light outgoing portion, the first reflection film, the first transflective film, and the second reflection film are parallel to each other, and are inclined at a predetermined angle with respect to the light incident surface of the optical waveguide, the predetermined angle is configured such that the laser light incident into the optical waveguide is totally reflected in the optical waveguide, and a distance between the first transflective film and the second reflection film is equal to the beam width of the red laser light emitted by the plurality of first light emitting chips.

3. The projection device according to claim 1, wherein the optical waveguide comprises a sawtooth-shaped optical waveguide, and the sawtooth-shaped optical waveguide comprises:
a second body;
a third reflection film provided in the second body; and
a prism portion provided in the second body and located on the light incident surface of the optical waveguide, wherein the prism portion comprises a plurality of sub-prisms arranged in parallel, each sub-prism is strip-shaped, the plurality of sub-prisms comprise two or more sub-prisms adjacent to the third reflection film, a second transflective film is provided on a surface of each of the two or more sub-prisms facing the third reflection film, the plurality of sub-prisms comprise at least one sub-prism away from the third reflection film, a fourth reflection film is provided on a surface of each of the at least one sub-prism facing the third reflection film;
wherein the third reflection film constitutes the light incident portion, the prism portion constitutes the light outgoing portion, the third reflection film is spaced apart from the prism portion by a predetermined distance, and a width of the prism portion is equal to the beam width of the red laser light emitted from the plurality of first light emitting chips.

4. The projection device according to claim 2, wherein a reflectance of the first transflective film is 50%, and a transmittance of the first transflective film is 50%.

5. The projection device according to claim 2, wherein the at least one optical waveguide comprises one optical waveguide, the first reflection film is located on the light outgoing side of the plurality of third light emitting chips and is configured to reflect the green laser light, the first transflective film is configured to reflect a first part of the green laser light from the first reflection film and transmit a second part of the green laser light from the first reflection film, and the second reflection film is located on a light outgoing side of the plurality of first light emitting chips and is configured to reflect the green laser light and transmit the red laser light.

6. The projection device according to claim 3, wherein the at least one optical waveguide comprises one optical waveguide, the third reflection film is located on the light outgoing side of the plurality of third light emitting chips and is configured to reflect the green laser light, the prism portion is located on a light outgoing side of the plurality of first light emitting chips, the second transflective film on the two or more sub-prisms is configured to reflect a first part of the green laser light from the third reflection film and transmit a second part of the green laser light from the third reflection film, and the fourth reflection film on the at least one sub-prism is configured to reflect the green laser light and transmit the red laser light.

7. The projection device according to claim 1, wherein the at least one optical waveguide comprises:
a first optical waveguide located on the light outgoing side of the plurality of third light emitting chips, the first optical waveguide being configured to expand a beam width of the green laser light emitted from the plurality of third light emitting chips, so that the beam width of the green laser light emitted from the first optical waveguide is equal to the beam width of the red laser light emitted from the plurality of first light emitting chips; and
a second optical waveguide located on a light outgoing side of the plurality of second light emitting chips, the second optical waveguide being configured to expand a beam width of the blue laser light emitted from the plurality of second light emitting chips, so that a beam width of the blue laser light emitted from the second optical waveguide is equal to the beam width of the red laser light emitted from the plurality of first light emitting chips.

8. The projection device according to claim 1, wherein the at least one laser comprises one laser, the laser comprises the plurality of first light emitting chips, the plurality of second light emitting chips and the plurality of third light emitting chips, and the at least one optical waveguide is located on a light outgoing side of the laser.

9. The projection device according to claim 1, wherein the at least one laser comprises:
a first laser comprising the plurality of first light emitting chips; and
a second laser comprising the plurality of second light emitting chips and the plurality of third light emitting chips, the at least one optical waveguide being located on a light outgoing side of the second laser.

10. The projection device according to claim 1, wherein the light source further comprises a first light combining mirror assembly located on a light outgoing side of the at least one laser and configured to combine the red laser light, the green laser light, and the blue laser light.

11. The projection device according to claim 10, wherein the light source further comprises a diffusion sheet and a converging lens, the diffusion sheet and the converging lens are located between the first light combining mirror assembly and the optical modulating assembly, the diffusion sheet is located on a light outgoing side of the first light combining mirror assembly, and the converging lens is located on a light outgoing side of the diffusion sheet.

12. The projection device according to claim 5, wherein the light source further comprises an optical waveguide light combining mirror assembly, and the optical waveguide light combining mirror assembly is located on a light outgoing side of the at least one laser and the optical waveguide, and is configured to combine the red laser light, the green laser light, and the blue laser light.

13. The projection device according to claim 12, wherein the optical waveguide light combining mirror assembly comprises two light combining mirrors, one of the two light combining mirrors is located on a light outgoing side of the plurality of second light emitting chips and is configured to reflect the blue laser light, the other of the two light combining mirrors is located on a light outgoing side of the optical waveguide and is configured to reflect the red laser light and the green laser light and transmit the blue laser light, and the two light combining mirrors are parallel to each other and are inclined by a preset angle with respect to a plane where the optical waveguide is located.

14. The projection device according to claim 1, wherein the optical modulating assembly comprises:
a light homogenizing member located on a light outgoing side of the light source and configured to homogenize the illumination beam incident thereon;
a volume grating located on a light outgoing side of the light homogenizing member and configured to diffract the illumination beam from the light homogenizing member, a thickness, a period, and a refractive index variation of the volume grating satisfying that a spot size and an outgoing angle of the laser light diffracted by the volume grating satisfy an incident condition of an optical modulation member, a predetermined angle is formed between a light outgoing surface of the volume grating and a light incident surface of the optical modulation member, and the predetermined angle satisfies an incident angle condition required when the laser light is incident on the optical modulation member; and
the optical modulation member located on a light outgoing side of the volume grating and configured to modulate the illumination beam transmitted from the volume grating to obtain the projection beam.

15. The projection device according to claim 14, wherein the volume grating is located on a side edge of the optical modulation member, and the light homogenizing member is located on a side of the volume grating away from the optical modulation member; and
the optical modulating assembly further comprises a reflection mirror assembly, the reflection mirror assembly is located on the light outgoing side of the light homogenizing member and is configured to reflect the illumination beam transmitted from the light homogenizing member to the volume grating, so that the illumination beam reflected by the reflection mirror assembly is incident on the volume grating at a Bragg angle, and the reflection mirror assembly comprises a reflection mirror.

16. The projection device according to claim 15, wherein the optical modulating assembly further comprises a collimating lens assembly, the collimating lens assembly is located between the light homogenizing member and the reflection mirror assembly and is configured to collimate the illumination beam transmitted from the light homogenizing member, and the illumination beam collimated by the collimating lens assembly is incident on the reflection mirror assembly.

17. The projection device according to claim 16, wherein the light homogenizing member comprises a light guide, and the light guide extends in a direction parallel to the side edge of the optical modulation member.

18. The projection device according to claim 17, wherein the light guide is wedge-shaped, an area of a cross section of the light guide perpendicular to a transmission direction of the illumination beam decreases along the transmission direction of the illumination beam, and the light guide comprises:
a first end adjacent to the light source, the first end configured to receive the illumination beam from the light source; and
a second end away from the light source, an area of a cross section of the first end perpendicular to the transmission direction of the illumination beam being greater than an area of a cross section of the second end perpendicular to the transmission direction of the illumination beam, and the illumination beam homogenized by the light guide being transmitted out of the light guide from the second end.

19. The projection device according to claim 15, wherein the reflection mirror assembly comprises two first reflection mirrors arranged at a predetermined angle.

20. A projection system comprising:
the projection device according to claim 1; and
a projection screen located on a light outgoing side of the projection device, the projection screen being configured to receive the projection beam from the projection device to form the projection image.
